(19) United States
(12) Patent Application Publication
(10) Pub. No.: US 2006/0014094 A1
(43) Pub. Date: Jan. 19, 2006

(54) Two-component developer and method of forming image therewith

(75) Inventors: Yasuhito Yuasa, Katano-shi (JP); Kiminori Umeda, Amagasaki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Electric Industrial Co., Ltd., Kadoma-shi (JP)

(21) Appl. No.: 10/533,231

(22) PCT Filed: Oct. 23, 2003
(86) PCT No.: PCT/JP03/13519

§ 371 Date: Apr. 29, 2005

(30) Foreign Application Priority Data
Oct. 30, 2002 (JP) 2002-316615

(51) Int. Cl. G03G 9/08

(52) U.S. Cl. 430/108.2; 430/108.4; 430/111.35; 430/108.1; 430/120; 430/126

(57) ABSTRACT

The two-component developer of the present invention comprises a carrier coated with a resin composition containing an aminosilane coupling agent and a fluorine-modified silicone resin, and a toner that contains a wax selected from among the following A to D, which increases OHP light transmissivity, prevents offset, and prolongs service life.
A) A synthetic wax with a DSC endothermic peak temperature of 80 to 120° C. and an acid value of 5 to 80 mgKOH/g, obtained by reacting a C₄ to C₃₀ long chain alkyl alcohol, an unsaturated polycarboxylic acid or anhydride thereof, and an unsaturated hydrocarbon wax B) An ester wax with a DSC endothermic peak temperature of 50 to 120° C., an iodine value of 25 or less, and a saponification value of 30 to 300
C) A fatty acid amide wax selected from among C₁₆ to C₂₄ aliphatic amide waxes and alkylene bis fatty acid amides of saturated, monounsaturated, or diunsaturated fatty acids D) A fatty acid ester wax selected from among hydroxystearic acid derivatives, glycerol fatty acid esters, glycol fatty acid esters, and sorbitan fatty acid esters.

### TECHNICAL FIELD

This invention relates to a two-component developer and an image formation method used in copiers, laser printers, plain paper fax machines, color PPCs, color laser printers, color fax machines, and devices that combine these functions.

### BACKGROUND ART

Electronic copiers in recent years have been shifting from office use to personal use, and this has been accompanied by a need for these devices to be smaller and faster, to provide higher image quality, to be maintenance-free, and so on. Accordingly, some of the requirements these devices now must meet include use of a cleaner-less process in which waste toner is recovered in developing, without having to clean away waste toner left behind after transfer; the use of a tandem color process with which color images can be outputted at high speed; low ozone emission; easy maintenance; and oil-less fixing, with which a sharp color image having high gloss and high optical transmissivity can be obtained with no offset even without the use of a fixing oil for preventing offset during fixing. All of these functions must be realized at the same time, and improving toner characteristics, and not just the process, is an important factor.

With a color printer, an image support (hereinafter referred to as a photosensitive member) is charged by corona discharge (using a charger), after which the photosensitive member is irradiated with various colors of a latent image in the form of optical signals, thereby forming an electrostatic latent image. This is developed with a first color (such as yellow) toner to visualize the latent image. After this, a transfer member that has been charged to the opposite polarity of the charge of the yellow toner is brought into contact with the photosensitive member, which transfers the yellow toner image onto the photosensitive member. The photosensitive member is destaticized after cleaning away any toner remaining behind from transfer, which concludes the developing and transfer of the first color toner. The same operation is then repeated for magenta, cyan, and other toner colors, which builds up toner images of various colors on the transfer member and forms a color image. These superimposed toner images are then transferred onto paper that has been charged to the opposite polarity from that of the toner, and this constitutes a four-pass color process. There also has been a proposal for a tandem color process in which a primary transfer process first is executed by disposing in a row a plurality of image formation stations having a charger, a photosensitive member, a developing unit, and so forth, and bringing an endless transfer member into contact with the photosensitive member to continuously transfer consecutive colors of toner to the transfer member, so that a multilayer transferred color toner image is formed on the transfer member, and then a secondary transfer process is executed by transferring the multilayer toner image formed on the transfer member all at once to a transfer medium such as paper or an overhead projector (OHP) sheet, as well as a proposal for a tandem color process involving direct transfer to the paper, OHP sheet, or other transfer medium, without using a transfer member.

In the fixing process, with a color image, the color toner must be melted to mix the colors and increase optical transmissivity. If the toner does not melt sufficiently, light will be scattered on the surface or in the interior of the toner image, resulting in a loss of the original color tone of the toner dye and preventing the light from reaching lower layers in overlapping portions, which decreases color reproducibility. Therefore, one of the conditions required of a toner is that it be capable of completely melting and have enough optical transmissivity that color tone will not be impaired. The need for OHP sheets to have good optical transmissivity has increased as color presentations have become more commonplace. When a color image is obtained, offset occurs when toner adheres to the surface of the fixing roller, so that the fixing roller has to be coated with a large quantity of oil or the like, which complicates handling and device configuration. Consequently, there is a need for oil-less fixing, in which no oil is used during fixing (discussed below), in order to make devices smaller, easier to maintain, and less expensive. A design in which a wax or other such release agent is added to a binder resin having sharp melting characteristics is starting to be put to use in an effort to accomplish this goal.

However, a problem with a toner such as this is that the toner has the property of being highly cohesive, so that toner image disruption during transfer and the tendency toward poor transfer tend to be more pronounced, making it difficult to achieve both good transfer and good fixing. Also, in the course of two-component developing, toner-spent tends to occur, in which the low melting point component of the toner adheres to the carrier surface as a result of heat generated by mechanical impact and friction, such as impact and friction between particles, or impact and friction between particles and the developing unit. This diminishes the ability of the carrier to be charged, and shortens the service life of the developer.

In an effort to provide an extended-life coating carrier, it has been proposed in Patent Documents 1 to 3 (see below) that the surface of a carrier core be coated with a resin of a copolymer of a vinyl monomer and a nitrogen-containing fluoroalkyl (meth)acrylate, a copolymer of a nitrogen-containing vinyl monomer and a fluoroalkyl (meth)acrylate, or the like. It is stated in these documents that a coating carrier with a relatively long service life can be obtained by coating the carrier core surface with a solvent-soluble fluorine-containing polymer having imide bonds, or a copolymer of a nitrogen-containing monomer and a fluorinated monomer.

Nevertheless, the resin adhesive strength is low at the adhesive boundary with the carrier, and the strength of the resin is too low, so that adequate impact resistance has yet to be obtained. Also, the chargeability of fluorine makes it difficult to negatively charge the toner, so that an adequate charge cannot be imparted to the toner, resulting in image fogging, uneven density, and other such problems.

In Patent Documents 4 and 5 there is proposed a carrier coated with a silicone resin containing an aminosilane coupling agent in combination with a toner of specific components in an effort to improve the durability of a developer by preventing a decrease in toner charge in atmospheres of high humidity, but these approaches were inadequate in terms of preventing toner-spent.

In Patent Document 6 there is proposed a carrier in which fluorine-substituted alkyl groups have been introduced into the silicone resin of a coating layer, as opposed to positively chargeable toner. In Patent Document 7 there is proposed a coating carrier containing electroconductive carbon and a crosslinked fluorine-modified silicone resin, which affords better developing performance in a high speed process, and this performance does not deteriorate over an extended period, in a high speed process. This takes advantage of the excellent charging characteristics of a silicone resin, and the fluorine-substituted alkyl groups impart lubricity, partability, water repellency, and other such benefits, make wear, separation, cracking, and the like less likely to occur, and prevent toner-spent. However, not only is the effect unsatisfactory in terms of wear, separation, cracking, and the like, but while suitably charging is obtained with a positively chargeable toner, when a negatively chargeable toner is used, the amount of charge is too low, oppositely chargeable toner (positively chargeable toner) is generated in large quantity, fogging, toner scattering, and other such problems occur, and the product cannot stand up to use.

A variety of toner compositions also have been proposed. As is well known, a toner for electrostatic charge developing used in electrophotography generally consists of a resin component (binder resin), a coloration component composed of a pigment or dye, a plasticizer, a charge control agent, and any necessary additives such as a release agent. A natural or synthetic resin is used, either singly or as a suitable mixture, as the resin component.

The above-mentioned additives are pre-mixed in an appropriate ratio, the mixture is heated and kneaded by thermal melting, and finely pulverized with an air stream collision board, and the resulting fine powder is graded to complete a toner matrix. Chemical polymerization is another way to produce a toner matrix. After this, an additive such as hydrophobic silica is added to the toner matrix to complete the toner. Toner alone is used in single-component developing, while a two-component developer is obtained by mixing toner with a carrier composed of magnetic particles.

In Patent Document 8, a non-free fatty acid type of carnauba wax and/or a montan-based ester wax and an oxidized rice wax with an acid value of 10 to 30 are used as the release agent and wax, while a vinyl copolymer having a melting point of 85 to 100° C. that is polymerized in the presence of a natural gas-based Fischer-Tropsch wax is used in Patent Document 9, and Patent Document 10 discloses that a polyhydric alcohol component is polycondensed with a dicarboxylic acid and a trivalent or higher carboxylic acid compound, the average dispersed particle size of the release agent is from 0.1 to 3 μm, the particle size of the additive is from 4 to 200 nm, and the addition is made in an amount of 1 to 5 parts by weight. Patent Document 11 discloses that fixability is enhanced by including a fluorine-modified polyolefin resin such as polypropylene that has been modified with an organofluorine compound such as perfluoro-octyl methacrylate. In Patent Document 12 it is stated that a toner with excellent fixability, offset resistance, and optical transmissivity can be obtained by using a product obtained from a synthetic hydrocarbon wax and an unsaturated polyvalent alkylcarboxylic acid and an alkyl alcohol or amine. In Patent Document 13 it is disclosed that offset resistance during fixing is improved by blending a molten mixture of polytetrafluoroethylene and a low-molecular weight polyolefin, and a low-molecular weight polyolefin containing fluorine and having a softening point of 80 to 140° C., and it is stated that this is effective at improving fixability.

The purpose of adding a low-melting point release agent such as polyethylene or polypropylene wax to a resin composition obtained by blending or copolymerizing these high and low molecular weight components is to improve parting from a heat roller during fixing, and thereby increase offset resistance. However, it is difficult to increase the dispersibility of these release agents in a binder resin, oppositely chargeable toner tends to be generated, and fogging occurs in the non-image portions. Filming also tends to occur on the photosensitive member.

A particular problem is the phenomenon whereby the surface of the carrier, which is the toner transport and charging member, is contaminated in the course of using as a two-component developer a toner to which one of these release agents has been added (called toner-spent). Accordingly, there is a decrease in charging performance, as well as a drop in toner transport performance. Furthermore, the carrier tends to adhere to the photosensitive member, which is a cause of damage to the intermediate transfer member. Therefore, currently the carrier is replaced and discarded after being used for a certain length of time, which drives up the running costs.

Patent Document 1: JP S61-80161A

Patent Document 2: JP S61-80162A

Patent Document 3: JP S61-80163A

Patent Document 4: Japanese Patent 2,619,439

Patent Document 5: Japanese Patent 2,744,790

Patent Document 6: Japanese Patent 2,801,507

Patent Document 7: JP 2002-23429A

Patent Document 8: JP H2-266372A

Patent Document 9: JP H9-281748A

Patent Document 10: JP H10-327196A

Patent Document 11: JP H5-333584A

Patent Document 12: JP 2000-10338A

Patent Document 13: JP H5-188632A

### DISCLOSURE OF INVENTION

It is an object of the present invention to achieve oil-less fixing by using a wax or other release agent in an oil-less fixing toner with which no oil is used on the fixing roller. It is another object of the present invention to provide a two-component developer that has good durability and does not lead to carrier deterioration through toner-spent even when used in combination with a toner containing wax or another such release agent. It is yet another object of the present invention to impart suitable negative chargeability to a toner to which a wax has been added, and suitably maintain the image density and fogging level.

The two-component developer of the present invention is a two-component developer comprising a carrier and a toner containing a binder resin, a colorant, a wax, and an additive,

wherein the carrier comprises a core material whose surface is coated with a resin composition containing an aminosilane coupling agent and a fluorine-modified silicone resin, and

the wax contained in the toner is at least one wax selected from the following A to D.

A) A synthetic wax with a DSC endothermic peak temperature of 80 to 1200C and an acid value of 5 to 80 mgKOH/g, obtained by reacting at least a C₄ to C₃₀ long chain alkyl alcohol, an unsaturated polycarboxylic acid or anhydride thereof, and an unsaturated hydrocarbon wax.

B) An ester wax with a DSC endothermic peak temperature of 50 to 120° C., an iodine value of 25 or less, and a saponification value of 30 to 300.

C) At least one fatty acid amide wax selected from among C₁₆ to C₂₄ aliphatic amide waxes and alkylene bis fatty acid amides of saturated, monounsaturated, or diunsaturated fatty acids.

D) At least one type of fatty acid ester wax selected from among hydroxystearic acid derivatives, glycerol fatty acid esters, glycol fatty acid esters, and sorbitan fatty acid esters.

The first image formation method of the present invention comprises a developing apparatus in which an AC bias with a frequency of 1 to 10 kHz and a bias of 1.0 to 2.5 kV (p-p) is applied along with a DC bias between a photosensitive member and a developing roller, and the peripheral speed ratio between the photosensitive member and the developing roller is from 1:1.2 to 1:2, and makes use of the above two-component developer of the present invention.

The second image formation method of the present invention comprises a transfer system in which there are a plurality of toner image forming stations consisting of at least an image support, charging means for forming an electrostatic latent image on the image support, and a toner support, the electrostatic latent image formed on the image support is visualized using the above two-component developer of the present invention, a primary transfer process, in which the toner image produced by the visualization of the electrostatic latent image is transferred to an endless transfer member by bringing the transfer member into contact with the image support, is sequentially and continuously executed to form a multilayer transferred toner image on the transfer member, and then a secondary transfer process, in which the multilayer toner image formed on the transfer member is transferred all at once to a transfer medium, is executed, and the transfer processes form an image under a condition of d1/v≦0.65 (sec), when d1 (mm) is the distance from a first primary transfer position to a second primary transfer position, or the distance from the second primary transfer position to a third primary transfer position, or the distance from the third primary transfer position to a fourth primary transfer position, and v (mm/s) is the peripheral speed of the photosensitive member.

The third image formation method of the present invention comprises a transfer system in which there are a plurality of toner image forming stations consisting of at least an image support, charging means for forming an electrostatic latent image on the image support, and a toner support, the electrostatic latent image formed on the image support is visualized using the above two-component developer of the present invention, a transfer process is executed in which the toner image produced by the visualization of the electrostatic latent image is transferred sequentially and continuously to a transfer medium, and the transfer process forms an image under a condition of d1/v≦0.65 (sec), when d1 (mm) is the distance from a first primary transfer position to a second primary transfer position, or the distance from the second primary transfer position to a third primary transfer position, or the distance from the third primary transfer position to a fourth primary transfer position, and v (mm/s) is the peripheral speed of the photosensitive member.

### BRIEF DESCRIPTION OF DRAWINGS

FIG. 1 is a cross section of the construction of an image formation apparatus used in a working example of the present invention;

FIG. 2 is a cross section of the construction of a fixing unit used in a working example of the present invention;

FIG. 3 is a simplified diagram of a toner kneading apparatus used in a working example of the present invention;

FIG. 4 is a plan view of a toner kneading apparatus used in a working example of the present invention;

FIG. 5 is a side view of a toner kneading apparatus used in a working example of the present invention;

FIG. 6 is a cross section of a toner kneading apparatus used in a working example of the present invention;

FIG. 7 is a diagram of the construction of a toner pulverization process used in a working example of the present invention;

FIG. 8 is a cross section of a toner pulverization process used in a working example of the present invention; and

FIG. 9 is a cross section of a toner pulverization process used in a working example of the present invention.

1: photosensitive member, 2: charging roller, 3: laser signal light, 4: developing roller, 5: blade, 10: first transfer roller, 12: transfer belt, 14: second transfer roller, 13: drive tensioning roller, 17: transfer belt unit, 18B, 18C, 18M, and 18Y: image formation units, 18: image formation unit group, 201: fixing roller, 202: press roller, 203: fixing belt, 205: induction heater, 206: ferrite core, 207: coil, 508: metering supply unit, 500: pulverizer, 501: rotor, 502: stator, 503: raw material, 506: jagged component, 509: cooling unit, 511: air, 512: thermometer, 514: bag filter, 515: cyclone, 516: airflow meter, 517: blower, 518: inorganic micropowder supply apparatus, 519: vibrator, 602: roll (RL1), 603: roll (RL2), 604: molten toner film wound onto roll (RL1), 605: inlet for heating medium, 606: outlet for heating medium

### BEST MODE FOR CARRYING OUT THE INVENTION

The present invention affords good digital image quality and more precise color reproduction, allows both optical transmissivity and offset resistance to be achieved, without the use of an oil for preventing offset on the fixing roller, and extends the service life by preventing toner-spent on the carrier in two-component developing.

(1) Carrier

A carrier having a carrier core and a resin coating layer composed of a fluorine-modified silicone resin containing an aminosilane coupling agent can be used preferably as the resin coated carrier in this embodiment. Examples of the carrier core include an iron powder-based carrier core, a ferrite-based carrier core, a magnetite-based carrier core, and a resin dispersed type of carrier core comprising a magnetic material dispersed in a resin. Examples of the ferrite-based carrier core here are generally expressed by the following formula.
(MO)x(Fe₂O₃)_{Y}

In the formula, M is at least one element selected from among Cu, Zn, Fe, Mg, Mn, Ca, Li, Ti, Ni, Sn, Sr, Al, Ba, Co, Mo, and the like. X and Y indicate the mole-based weight ratio and satisfy the condition X+Y=100.

At least one oxide of M (selected from among Cu, Zn, Fe, Mg, Mn, Ca, Li, Ti, Ni, Sn, Sr, Al, Ba, Co, Mo, and the like) is mixed with the main raw material Fe₂O₃, and this mixture is used as the raw material for the ferrite-based carrier core. An example of a method for manufacturing a ferrite-based carrier core is first to blend suitable amounts of the raw material such as the above-mentioned oxides, pulverize and mix these components for 10 hours in a wet ball mill, dry the mixture, and then keep this product at 950° C. for 4 hours. This product is pulverized for 24 hours in a wet ball mill, and polyvinyl alcohol (as a binder), an antifoaming agent, a dispersant, or the like is added to create a slurry with a raw material particle size of 5 μm or less. This slurry is granulated and dried, and these granules are kept at 1300° C. for 6 hours under a controlled oxygen concentration, and then pulverized and graded to the desired particle size distribution.

It is essential that the resin used for the resin coating layer of the present invention be a fluorine-modified silicone resin. This fluorine-modified silicone resin preferably is a crosslinkable fluorine-modified silicone resin obtained by reacting a polyorganosiloxane with an organosilicon compound containing perfluoroalkyl groups. The ratio in which the polyorganosiloxane and the organosilicon compound containing perfluoroalkyl groups are combined preferably is at least 3 parts by weight and no more than 20 parts by weight of the organosilicon compound containing perfluoroalkyl groups per 100 parts by weight polyorganosiloxane.

The polyorganosiloxane preferably has at least one repeating unit selected from among Chemical Formulas 1 and 2 below

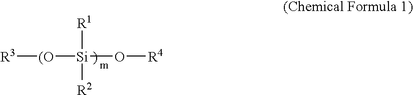

(Where R¹ and R² are each a hydrogen atom, halogen atom, hydroxy group, methoxy group, or C₁ to C₄ alkyl group or phenyl group, R³ and R⁴ are each a C₁ to C₄ alkyl group or phenyl group, and m is a positive integer (preferably in the range from 2 to 500, more preferably in the range from 5 to 200) indicating the average degree of polymerization.)

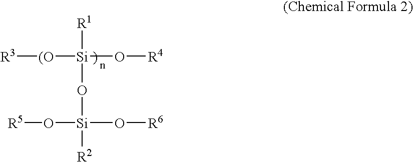

(Where R¹ and R² are each a hydrogen atom, halogen atom, hydroxy group, methoxy group, or C₁ to C₄ alkyl group or phenyl group, R³, R⁴, R⁵, and R⁶ are each a C₁ to C₄ alkyl group or phenyl group, and n is a positive integer (preferably in the range from 2 to 500, more preferably in the range from 5 to 200) indicating the average degree of polymerization.)

Examples of the perfluoroalkyl group-containing organosilicon compound include CF₃CH₂CH₂Si(OCH₃)₃, C₄F₉CH₂CH₂Si(CH₃)(OCH₃)₂, C₈F₁₇CH₂CH₂Si(OCH₃)₃, C₈F₁₇CH₂CH₂Si(OC₂H₅)₃, and (CH₃)₂CF(CF₂)₈CH₂CH₂Si(OCH₃)₃, but one that has a trifluoropropyl group is particularly preferable.

In this embodiment, an aminosilane coupling agent is contained in the resin coating layer. This aminosilane coupling agent may be a known agent such as γ-(2-aminoethyl)aminopropyltrimethoxysilane, γ-(2-aminoethyl)aminopropylmethyldimethoxysilane, and octadecylmethyl[3-(trimethoxysilyl)propyl] ammonium chloride (from the top, SH6020, SZ6023, and AY43-021, all trade names of Dow Corning Toray Silicone), and KBM602, KBM603, KBE903, and KBM573 (trade names of Shin-Etsu Silicone). A primary amine is particularly preferable. The polarity is weak with secondary or tertiary amines substituted with a methyl group, ethyl group, phenyl group, or the like, so that these have little effect on the charge rise characteristics with the toner. Also, when the amino group portion is an aminomethyl group, aminoethyl group, or aminophenyl group, then the silane coupling agent has a primary amine at its very end, but the amino groups in the straight-chain organic groups extending from the silane do not contribute to the charge rise characteristics with the toner, but are conversely affected by moisture under high humidity, so that although the carrier initially may be capable of imparting a charge with the toner due to the amino group at the end, this charge imparting capability decreases after repeated printings, so that the carrier ends up having a short service life.

The use of an aminosilane coupling agent such as this ensures a sharp charge quantity distribution in a positively-chargeable fluorine-modified silicone resin with respect to the toner, while allowing negative chargeability to be imparted, results in a fast charge rise in supplementally added toner, and reduces the amount of toner consumption. Furthermore, the aminosilane coupling agent has an effect similar to that of a crosslinking agent, and therefore increases the degree of crosslinking of the fluorine modified silicone resin layer serving as a base resin, further increases the coating resin hardness, reduces wear, separation, and so forth that results from extended use, improves resistance to toner-spent, stabilizes charging, and increases durability. Furthermore, if this is used in combination with a toner to which a specific low melting point wax has been added (discussed below), handling in the developing unit is facilitated, and there is better uniformity in density between the front and back sides in developing an image. Also, there is a reduction in what is known as developing memory, in which a history remains after a solid image is acquired.

The aminosilane coupling agent is used in a proportion of 5 to 40 wt %, and preferably 10 to 30 wt %, with respect to the resin. The aminosilane coupling agent will have no effect if this proportion is less than 5 wt %, but if 40 wt % is exceeded, the crosslinking of the resin coating layer will be too high, making it more likely that charge-up will occur, and causing image defects such as an insufficient development.

The resin coating layer also can contain electroconductive microparticles in order to stabilize charging and to prevent charge-up. Examples of such conductive microparticles include carbon blacks such as oil furnace carbon and acetylene black, semiconductive oxides such as titanium oxide and zinc oxide, and materials in which the surface of a powder such as titanium oxide, zinc oxide, barium sulfate, aluminum borate, or potassium titanate is coated with tin oxide, carbon black, or a metal. The resistivity of these particles preferably is 10¹⁰ Ω·cm or less. When conductive microparticles are used, they are preferably contained in an amount of 1 to 15 wt %. If a certain amount of conductive microparticles are contained in the resin coating layer, they will increase the hardness of the resin coating layer by a filler effect, but if the amount is over 15 wt %, they will conversely hinder the formation of the resin coating layer and cause a decrease in adhesiveness or hardness. Furthermore, if the conductive microparticles are contained in too large an amount in a full-color developer, they will cause toner color stains in the toner that is transferred and fixed to the paper surface.

The average particle size of the carrier in this embodiment preferably is 20 to 70 μm. If the average particle size of the carrier is less than 20 μm, the ratio of microparticles in the carrier particle distribution will be high and the amount of magnetization per carrier particle will be small, so that the carrier is more prone to being developed on the photosensitive member. If the average particle size of the carrier is more than 70 μm, however, the specific surface area of the carrier particles will be small and their toner holding power will be weak, resulting in toner scattering. Also, this is undesirable in full color development involving a large printing area ratio because the halftone image quality suffers.

There are no particular restrictions on how the coating layer is formed on the carrier core, and any known coating method may be employed. Examples include wet coating methods such as an immersion method in which a powder (the carrier core) is immersed in a solution for forming a coating layer, a spray method in which a solution for forming a coating layer is sprayed onto the surface of the carrier core, a fluidized bed method in which a solution for forming a coating layer is sprayed while the carrier core is fluidized with air, and a kneader coater method in which the carrier core and a solution for forming a coating layer are mixed in a kneader coater and the solvent is then removed; and a dry coating method in which a powdered resin and the carrier core are mixed at high speed and the frictional heat thus generated is utilized to fuse a coating of the powdered resin to the surface of the carrier core. Although any of these methods can be applied, it is particularly preferable to use a wet coating method for coating with a fluorine-modified silicone resin containing an aminosilane coupling agent as in the present invention.

There are no particular restrictions on the solvent used in the coating liquid for forming a coating layer, as long as it is one that will dissolve the coating resin, and the solvent may be selected as dictated by the coating resin being used. Examples of the solvent typically include aromatic hydrocarbons such as toluene and xylene, ketones such as acetone and methyl ethyl ketone, and ethers such as tetrahydrofuran and dioxane.

The amount of resin coating in the present invention is from 0.1 to 5.0 wt % with respect to the carrier core. If the amount of resin coating is less than 0.1 wt %, a uniform coating cannot be formed on the carrier surface, and the influence of the characteristics of the carrier core will be so strong that the effect of the fluorine-modified silicone resin and the aminosilane coupling agent of the present invention cannot be fully realized. If the amount is more than 5.0 wt %, the coating layer will be too thick, granulation will occur among the carrier particles, and there will be a tendency for uniform carrier particles not to be obtained.

After coating the surface of the carrier core with the fluorine-modified silicone resin containing an aminosilane coupling agent in this manner, it is preferable to perform a baking treatment. There are no particular restrictions on the means for performing this baking treatment, and it may involve either external or internal heating. For example, the baking may be performed by using an electric furnace with a fixed or a fluidized bed, a rotary kiln electric furnace, or a burner furnace, or microwaves may be used. As to the temperature in the baking treatment, however, in order for the effect of the fluorosilicone (improving the toner-spent resistance of the resin coating layer) to be efficiently exhibited, the treatment preferably is conducted at a high temperature of from 200 to 350° C., and more preferably from 220 to 280° C. A treatment duration of 0.5 to 2.5 hours is suitable. The hardness of the coating resin itself will decrease if the treatment temperature is too low, but charging will decrease if the treatment temperature is too high.

(2) Wax

The wax added to the toner of this embodiment is one with an iodine value of 25 or less and a saponification value of 30 to 300. Adding this wax in an amount of 5 to 20 parts by weight per 100 parts by weight of binder resin lessens the repulsion of the toner caused by charge action during multilayer toner transfer, and suppresses a decrease in transfer efficiency, partial transfer defects, and back transfer. Also, when this wax is used in combination with the carrier discussed above, toner-spent occurs less often on the carrier, which extends the service life of the developer. In addition, handling in the developing unit is facilitated, and there is better uniformity of the image between the front and back sides in developing. The wax also reduces the occurrence of developing memory.

It is preferable for the acid value of the binder resin to be from 1 to 40 mgKOH/g. The binder resin preferably is added in an amount of 5 to 20 parts by weight per 100 parts by weight of binder resin. No increase in fixability will be obtained below 5 parts by weight, but exceeding 20 parts by weight poses problems with storage stability. If the iodine value is greater than 25, there will be only minimal reduction in toner repulsion caused by charge action during multilayer toner transfer in primary transfer. Environmental dependence will be high, the chargeability of a material will vary greatly during long-term continuous use, and the stability of the image will be impaired. Developing memory will also be more apt to occur. If the saponification value is lower than 30, more saponified material and hydrocarbons will be present, filming will occur on the photosensitive member, and chargeability will suffer. Dispersibility in a charge control agent will also be poor, and this can lead to filming or a decrease in chargeability during continuous use. If the saponification value is over 300, the dispersibility of the wax in the resin will be poor, and there will be only minimal reduction in toner repulsion caused by charge action. This will also lead to more fogging and toner scattering. If the resin acid value is less than 1 mgKOH/g, there will be only minimal reduction in toner repulsion caused by charge action during multilayer toner transfer. If the resin acid value is greater than 40 mgKOH/g, environmental resistance will-suffer, and this will lead to more fogging.

The melting point (as found by DSC) preferably is 50 to 120° C. Even more preferable is a wax with an iodine value of 15 or less, a saponification value of 50 to 250, and a DSC melting point of 55 to 90° C., and more preferable still is a wax with an iodine value of 5 or less, a saponification value of 70 to 200, and a DSC melting point of 60 to 85° C.

It is preferable to use a material that increases in volume by 2 to 30% at a 10° C. change at a temperature over the melting point. The wax expands rapidly upon changing from a solid to a liquid, so that when it is melted by heat during fixing, the toner particles adhere together more tightly, which further improves fixability, parting from the fixing roller is better, and offset resistance is also increased. There will be little effect if the increase in volume is less than 2%, but dispersibility during kneading will decrease if the increase is more than 30%.

The heating loss of the wax at 220° C. preferably is no more than 8 wt %. If the heating loss is greater than 8 wt %, the binder wax will remain in the binder resin during heating and kneading, greatly reducing the glass transition point of the binder resin and decreasing the storage stability of the toner. This has an adverse effect on developing characteristics, and produces fogging and photosensitive member filming.

The wax with an iodine value of 25 or less and a saponification value of 30 to 300 preferably has the following molecular weight characteristics as determined by gel permeation chromatography (GPC): a number average molecular weight of 100 to 5000, a weight average molecular weight of 200 to 10,000, a ratio of weight average molecular weight to number average molecular weight (weight average molecular weight/number average molecular weight) of 1.01 to 8, a ratio of the Z average molecular weight to the number average molecular weight (Z average molecular weight/number average molecular weight) of 1.02 to 10, and there is at least one molecular weight maximum peak in the molecular weight region from 5×10² to 1×10⁴. Even more preferably, the number average molecular weight is from 500 to 4500, the weight average molecular weight is from 600 to 9000, the ratio of weight average molecular weight to number average molecular weight (weight average molecular weight/number average molecular weight) is from 1.01 to 7, and the ratio of the Z average molecular weight to the number average molecular weight (Z average molecular weight/number average molecular weight) is from 1.02 to 9. More preferably still, the number average molecular weight is from 700 to 4000, the weight average molecular weight is from 800 to 8000, the ratio of weight average molecular weight to number average molecular weight (weight average molecular weight/number average molecular weight) is from 1.01 to 6, and the ratio of the Z average molecular weight to the number average molecular weight (Z average molecular weight/number average molecular weight) is from 1.02 to 8. Storage stability will worsen if the number average molecular weight is less than 100 or if the weight average molecular weight is less than 200. If the molecular weight maximum peak is located below 5×10², the dispersibility of the charge control agent with the wax will suffer. Also, handling in the developing unit will be more difficult, and toner density cannot be kept as uniform. A decrease in the storage stability of the toner results in photosensitive member filming. If the number average molecular weight is greater than 5000, or the weight average molecular weight is greater than 10,000, or the ratio of weight average molecular weight to number average molecular weight (weight average molecular weight/number average molecular weight) is greater than 8, or the ratio of the Z average molecular weight to the number average molecular weight (Z average molecular weight/number average molecular weight) is greater than 10, or the molecular weight maximum peak is located above 1×10⁴, the parting action will be weaker and there will be a decrease in fixability function, such as fixability and offset resistance.

The wax preferably is a natural wax such as a meadowfoam oil derivative, carnauba wax, a jojoba oil derivative, Japan wax, beeswax, ozocerite, carnauba wax, candelilla wax, montan wax, ceresin wax, and rice wax, a synthetic wax such as Fischer-Tropsch wax, or another such material. Just one type may be used, or a combination of two or more types may be used. It is particularly preferable to use one or more types of wax selected from the group consisting of carnauba wax (DSC melting point of 76 to 90° C.), candelilla wax (66 to 80° C.), hydrogenated jojoba oil (64 to 78° C.), hydrogenated meadowfoam oil (64 to 78° C.), or rice wax (74 to 90° C.).

The saponification value refers to the number of milligrams of potassium hydroxide (KOH) required to saponify 1 g of sample, and corresponds to the sum of the acid value and the ester value. To measure the saponification value, the sample was saponified in an approximately 0.5 N alcohol solution of potassium hydroxide, after which the excess potassium hydroxide was titrated with 0.5 N hydrochloric acid. The iodine value is expressed by the number of grams, per 100 g of sample, when a halogen is allowed to act on the sample and the amount of absorbed halogen is calculated as iodine, and is the number of grams of iodine absorbed by 100 g of fatty acid. The greater this value is, the higher is the degree of fatty acid unsaturation in the sample. An alcohol solution of iodine and mercury chloride(II) or a glacial acetic acid solution of iodine chloride is added to a chloroform or carbon tetrachloride solution of the sample, and the iodine that remains unreacted after the system has been allowed to stand is titrated with a sodium thiosulfate standard solution to calculate the amount of absorbed iodine.

The heating loss is measured by precisely weighing the sample cell to 0.1 mg (W1 mg), putting 10 to 15 mg of sample in this cell, and precisely weighing to 0.1 mg (W2 mg). The sample cell is placed in a differential thermal balance, and measurement is commenced with the weighing sensitivity set to 5 mg. Temperature control is performed by the following program. After measurement, the weight loss is read to 0.1 mg (W3 mg) from a chart-at the point when the sample temperature reaches 220° C. The apparatus used here was a TGD-3000 made by Shinku Riko, the temperature elevation rate was 10° C./min, the maximum temperature was 220° C., the holding time was 1 minute, and the result was calculated from the equation: heating loss (%)=W3/(W2−W1)×100.

The meadowfoam oil derivative preferably is a meadowfoam oil fatty acid, a metal salt of a meadowfoam oil fatty acid, a meadowfoam oil fatty acid ester, a hydrogenated meadowfoam oil, a meadowfoam oil amide, a homomeadowfoam oil amide, a meadowfoam oil triester, a maleic acid derivative of epoxidized meadowfoam oil, an isocyanate polymer of a meadowfoam oil fatty acid polyhydric alcohol ester, or a halogen-modified meadowfoam oil. These materials are preferred because they improve transfer and extend the service life of the developer and oil-less fixing. These can be used singly or in combinations of two or more types.

Preferable examples of meadowfoam oil fatty acid esters include methyl, ethyl, butyl, glycerol, pentaerythritol, polypropylene glycol, trimethylolpropane esters. A meadowfoam oil fatty acid pentaerythritol monoester, a meadowfoam oil fatty acid pentaerythritol triester, a meadowfoam oil fatty acid trimethylol propane ester, or the like is particularly preferable because it will afford good cold offset resistance as well as offset resistance at high temperatures.

A hydrogenated meadowfoam oil is obtained by hydrogenating meadowfoam oil to convert the unsaturated bonds into saturated bonds. This improves offset resistance as well as gloss and optical transmissivity.

A meadowfoam oil amide can be obtained by hydrolyzing meadowfoam oil, and then producing a fatty acid methyl ester by esterification, and finally reacting this ester with a mixture of concentrated aqueous ammonia and ammonium chloride. The melting point of this product can be adjusted by hydrogenation. It is also possible to perform this hydrogenation prior to hydrolysis. A product with a melting point of 75 to 120° C. is obtained. A homomeadowfoam oil amide can be obtained by hydrolyzing meadowfoam oil, and then reducing this product to an alcohol, and then converting this into a nitrile. This improves offset resistance as well as gloss and optical transmissivity.

The jojoba oil derivative preferably is a jojoba oil fatty acid, a metal salt of a jojoba oil fatty acid, a jojoba oil fatty acid ester, hydrogenated jojoba oil, a jojoba oil amide, a homojojoba oil amide, a jojoba oil triester, a maleic acid derivative of epoxidized jojoba oil, an isocyanate polymer of a jojoba oil fatty acid polyhydric alcohol ester, or a halogen-modified jojoba oil. These materials are preferred because they improve transfer and extend the service life of the developer and oil-less fixing. These can be used singly or in combinations of two or more types.

Preferable examples of jojoba oil fatty acid esters include methyl, ethyl, butyl, glycerol, pentaerythritol, polypropylene glycol, trimethylolpropane esters. A jojoba oil fatty acid pentaerythritol monoester, a jojoba oil fatty acid pentaerythritol triester, a jojoba oil fatty acid trimethylol propane ester, or the like is particularly preferable because it will afford good cold offset resistance as well as offset resistance at high temperatures.

A hydrogenated jojoba oil is obtained by hydrogenating jojoba oil to convert the unsaturated bonds into saturated bonds. This improves offset resistance as well as gloss and optical transmissivity.

A jojoba oil amide can be obtained by hydrolyzing jojoba oil, and then producing a fatty acid methyl ester by esterification, and finally reacting this ester with a mixture of concentrated aqueous ammonia and ammonium chloride. The melting point of this product can be adjusted by hydrogenation. It is also possible to perform this hydrogenation prior to hydrolysis. A product with a melting point of 75 to 120° C. is obtained. A jojoba oil amide can be obtained by hydrolyzing jojoba oil, and then reducing this product to an alcohol, and then converting this into a nitrile. This improves offset resistance as well as gloss and optical transmissivity.

A hydroxystearic acid derivative, a glycerol fatty acid ester, a glycol fatty acid ester, a sorbitan fatty acid ester, or another such polyhydric alcohol fatty acid ester is the preferred material in this embodiment, and these can be used singly or in combinations of two or more types. When used in combination with the above-mentioned carrier, these afford oil-less fixing, extend the service life of the developer, maintain uniformity in the developing unit, and suppress the occurrence of developing memory.

Preferable examples of derivatives of hydroxystearic acid include methyl 12-hydroxystearate, butyl 12-hydroxystearate, propylene glycol mono-12-hydroxystearate, glycerol mono-12-hydroxystearate, and ethylene glycol mono-12-hydroxystearate. These have the effect of preventing filming and preventing adhesion to the paper in oil-less fixing.

Preferable examples of glycerol fatty acid esters include glycerol monostearate, glycerol tristearate, glycerol stearate, glycerol monopalmitate, and glycerol tripalmitate. These have the effect of preventing a decrease in transferability and lessening cold offset at low temperatures in oil-less fixing.

Preferable examples of glycol fatty acid esters include propylene glycol fatty acid esters such as propylene glycol monopalmitate and propylene glycol monostearate, and ethylene glycol fatty acid esters such as ethylene glycol monostearate and ethylene glycol monopalmitate. These have the effect of affording oil-less fixing, improving lubricity in developing, and preventing toner-spent on the carrier.

Preferable examples of sorbitan fatty acid esters include sorbitan monopalmitate, sorbitan monostearate, sorbitan tripalmitate, and sorbitan monotristearate. Other preferable materials include a stearic acid ester of pentaerythritol and a mixed ester of adipic acid and stearic acid or oleic acid, and these can be used singly or in combinations of two or more types. These have the effect of preventing filming and preventing adhesion to the paper in oil-less fixing.

Also, an aliphatic amide wax is added in this embodiment. This greatly increases the optical transmissivity in a color image. In particular, it promotes smoothness on the surface of a fixed image, allowing a high-quality color image to be obtained. It further prevents the adhesion of the transfer paper to the fixing roll during fixing, allowing both optical transmissivity and offset resistance to be achieved, and preventing partial transfer defects. When used in combination with the above-mentioned carrier, this affords oil-less fixing, suppresses the occurrence of toner-spent, extends the service life of the developer, maintains uniformity in the developing unit, and suppresses the occurrence of developing memory.

The aliphatic amide wax preferably is a C₁₆ to C₂₄ saturated or monounsaturated aliphatic amide such as palmitic acid amide, palmitoleic acid amide, stearic acid amide, oleic acid amide, arachidic acid amide, eicosenoic acid amide, behenic acid amide, erucic acid amide, and lignoceric acid amide, having a melting point of 60 to 120° C., and preferably 70 to 100° C., and even more preferably 75 to 95° C. The added amount preferably is 1 to 20 parts by weight per 100 parts by weight of binder resin. If the melting point is under 60° C., there will be a decrease in dispersibility in the resin and filming will be more apt to occur on the photosensitive member. If the melting point is over 120° C., there will be a decrease in the smoothness of the fixed image surface and optical transmissivity will suffer. If the added amount is over 20 parts by weight, storage stability will decrease, but there will be no effect if the added amount is less than 5 parts by weight.

A wax based on an alkylenebis fatty acid amide of a saturated or a mono- or diunsaturated fatty acid is preferred, examples of which include methylene-bis-stearic acid amide, ethylene-bis-stearic acid amide, propylene-bis-stearic acid amide, butylene-bis-stearic acid amide, methylene-bis-oleic acid amide, ethylene-bis-oleic acid amide, propylene-bis-oleic acid amide, butylene-bis-oleic acid amide, methylene-bis-lauric acid amide, ethylene-bis-lauric acid amide, propylene-bis-lauric acid amide, butylene-bis-lauric acid amide, methylene-bis-myristic acid amide, ethylene-bis-myristic acid amide, propylene-bis-myristic acid amide, butylene-bis-myristic acid amide, methylene-bis-palmitic acid amide, ethylene-bis-palmitic acid amide, propylene-bis-palmitic acid amide, butylene-bis-palmitic acid amide, methylene-bis-palmitoleic acid amide, ethylene-bis-palmitoleic acid amide, propylene-bis-palmitoleic acid amide, butylene-bis-palmitoleic acid amide, methylene-bis-arachidic acid amide, ethylene-bis-arachidic acid amide, propylene-bis-arachidic acid amide, butylene-bis-arachidic acid amide, methylene-bis-eicosenoic acid amide, ethylene-bis-eicosenoic acid amide, propylene-bis-eicosenoic acid amide, butylene-bis-eicosenoic acid amide, methylene-bis-behenic acid amide, ethylene-bis-behenic acid amide, propylene-bis-behenic acid amide, butylene-bis-behenic acid amide, methylene-bis-erucic acid amide, ethylene-bis-erucic acid amide, propylene-bis-erucic acid amide, and butylene-bis-erucic acid amide.

This improves optical transmissivity in a color image and increases fixing roller offset resistance. This also suppresses the occurrence of toner-spent to the carrier and extends the service life of the developer.

The added amount preferably is 1 to 20 parts by weight per 100 parts by weight of binder resin. If the melting point is under 100° C., there will be a decrease in offset resistance. If the melting point is over 145° C., there will be a decrease in dispersibility in the resin and fogging will increase. There will be no effect if the added amount is less than 1 part by weight, but fogging will increase if the amount is over 20 parts by weight.

Moreover, the surface smoothness of a fixed image can be improved, and the optical transmissivity and offset resistance of a color image can be made even better, by using a wax in which the aliphatic amide and the alkylene bis fatty acid amide are used in a ratio of 3:7 to 7:3. The melting point here must be higher for the alkylene bis fatty acid amide than for the aliphatic amide. If the melting point of the alkylene bis fatty acid amide is too low, not only will offset resistance decrease, but the resin itself will be in a state of low softening and will be excessively pulverized during pulverization, so that there will be more micropowder, which leads to a drop in productivity.

In particular, since the aliphatic amide is a material with a low softening point, as compatibility with the resin progresses, the resin itself is plasticized, with the result that offset resistance and storage stability decrease, and partial transfer defects occur during extended use. Accordingly, if an alkylene bis fatty acid amide having a higher melting point is used in combination with an aliphatic amide having a lower melting point, there will be less plasticization of the resin itself, partial transfer defects can be prevented during extended use without losing the effect of the aliphatic amide in terms of high optical transmissivity and surface smoothness, and offset resistance and storage stability can be maintained. This also suppresses the occurrence of toner-spent on the carrier and extends the service life of the developer.

Also, in this embodiment, a wax obtained by reacting a C₄ to C₃₀ long chain alkyl alcohol, an unsaturated polycarboxylic acid or anhydride thereof, and an unsaturated hydrocarbon wax, or a wax obtained by reacting a long chain alkylamine, an unsaturated polycarboxylic acid or anhydride thereof, and an unsaturated hydrocarbon wax, or a wax obtained by reacting a long chain fluoroalkyl alcohol, an unsaturated polycarboxylic acid or anhydride thereof, and an unsaturated hydrocarbon wax, each of which has a molecular weight distribution (by GPC) such that the weight average molecular weight is from 1000 to 6000, the Z average molecular weight is from 1500 to 9000, the ratio of weight average molecular weight to number average molecular weight (weight average molecular weight/number average molecular weight) is from 1.1 to 3.8, the ratio of the Z average molecular weight to the number average molecular weight (Z average molecular weight/number average molecular weight) is from 1.5 to 6.5, and there is at least one molecular weight maximum peak in the region from 1×10³ to 3×10⁴, and in which the acid value is from 5 to 80 mgKOH/g, the melting point is from 80 to 120° C., and the penetration at 25° C. is 4 or less, will be particularly effective in terms of improving separation between the paper and the fixing roller or belt with an image formed from three layers of color toner on thin paper. Such a wax is also effective at increasing OHP transmissivity without decreasing high temperature offset resistance. The addition of this wax also improves the fixing characteristics, and particularly high optical transmissivity, high gloss, and no offset in oil-less fixing, and does not diminish storage stability. Also, the offset of halftone images can be prevented by using a fluorine- or silicone-based member for the fixing roller. When used in combination with the above-mentioned carrier, this wax affords oil-less fixing, suppresses the occurrence of toner-spent on the carrier, extends the service life of the developer, maintains uniformity in the developing unit, and suppresses the occurrence of developing memory.

Furthermore, charging stability will be obtained over continuous use, allowing both fixability and charging stability to be achieved at the same time.

Also, partability, optical transmissivity, and other aspects of fixability, and charging stability and other aspects of developability can be improved further by increasing the state of dispersion during the addition of this wax to the binder resin. The addition of a release agent may in some cases lower the dispersibility of other internal additives, but with the constitution of the additives in this embodiment, good fixing and developing both can be achieved without decreasing the dispersibility.

If the carbon number of the long chain alkyl of the wax is less than 4, the parting action will be weak and there will be a drop in separability and high temperature offset resistance. If the carbon number of the long chain alkyl is greater than 30, though, there will be a decrease in dispersibility in the binder resin. An acid value of less than 5 mgKOH/g can lead to a decrease in the amount of charge when the toner is used for an extended period, but if the acid value is greater than 80 mgKOH/g, humidity resistance will decrease and there will be more fogging under high humidity. The storage stability of the toner will decrease if the melting point is below 80° C., but if the melting point is over 120° C., the parting action will be weak and the temperature range in which there is no offset will be narrower. Toughness will decrease and photosensitive member filming will occur over extended use if the penetration at 25° C. is less than 4.

If the weight average molecular weight is less than 1000, or the Z average molecular weight is less than 1500, or the weight average molecular weight/number average molecular weight is less than 1.1, or the Z average molecular weight/number average molecular weight is less than 1.5, or the molecular weight maximum peak is located below 1 x 103, there will be a decrease in the storage stability of the toner and filming will occur on the photosensitive member or the intermediate transfer member. Also, handling in the developing unit will be more difficult, and toner density uniformity will drop. Developing memory also will be more prone to occur.

If the weight average molecular weight is greater than 6000, or the Z average molecular weight is greater than 9000, or the weight average molecular weight/number average molecular weight is greater than 3.8, or the Z average molecular weight/number average molecular weight is greater than 6.5, or the molecular weight maximum peak is located above 3×10⁴, the parting action will be weaker and there will be a decrease in fixing offset resistance. Preferably, the weight average molecular weight is from 1000 to 5000, the Z average molecular weight is from 1700 to 8000, the ratio of weight average molecular weight to number average molecular weight (weight average molecular weight/number average molecular weight) is from 1.1 to 2.8, the ratio of the Z average molecular weight to the number average molecular weight (Z average molecular weight/number average molecular weight) is from 1.5 to 4.5, and there is at least one molecular weight maximum peak between 1×10³ and 1×10⁴, and even more preferably, the weight average molecular weight is from 1000 to 2500, the Z average molecular weight is from 1900 to 3000, the ratio of weight average molecular weight to number average molecular weight (weight average molecular weight/number average molecular weight) is from 1.2 to 1.8, the ratio of the Z average molecular weight to the number average molecular weight (Z average molecular weight/number average molecular weight) is from 1.7 to 2.5, and there is at least one molecular weight maximum peak between 1×10³ and 3×10³.

The alcohol here can be one having a long chain alkyl, such as octanol, dodecanol, stearyl alcohol, nonacosanol, or pentadecanol. Amines that can be used preferably include N-methylhexylamine, nonylamine, stearylamine, and nonadecylamine. Fluoroalkyl alcohols that can be used preferably include 1-methoxy-(perfluoro-2-methyl-1-propene), hexafluoroacetone, and 3-perfluorooctyl-1,2-epoxypropane. The unsaturated polycarboxylic acid or anhydride thereof can be maleic acid, maleic anhydride, itaconic acid, itaconic anhydride, citraconic acid, citraconic anhydride, or the like, which can be used singly or in combinations of two or more. Of these, maleic acid and maleic anhydride are preferred. Synthetic hydrocarbon waxes that can be used preferably include polyethylene, polypropylene, Fischer-Tropsch waxes, and α-olefins.

The product can be obtained by polymerizing an unsaturated polycarboxylic acid or anhydride thereof using an alcohol or an amine, and then adding this polymer to a synthetic hydrocarbon wax in the presence of dicumyl peroxide, tert-butyl peroxyisopropyl monocarbonate, or the like. The added amount preferably is 1 to 20 parts by weight per 100 parts by weight of binder resin. The parting effect will be minimal if the amount is less than 1 part by weight, but exceeding 20 parts by weight decreases the fluidity of the toner, and moreover there is no additional effect by adding any more.

Polyethylene, polypropylene, and other such polyolefin waxes, stearic acid, palmitic acid, lauric acid, aluminum stearate, barium stearate, zinc stearate, zinc palmitate, and other such higher fatty acids and metal salts thereof can be used preferably.

It is preferable for the dispersed average particle size of the wax in the binder resin to be from 0.1 to 1.5 μm, for particles smaller than 0.1 μm to account for no more than 35% of the dispersed average particle size distribution, for particles of 0.1 to 2.0 μm to account for at least 65%, and for particles larger than 2.0 μm to account for no more than 5%. The particle size and count were found from a cross sectional micrograph of the toner taken by TEM.

If the dispersed average particle size is less than 0.1 μm or if particles smaller than 0.1 μm account for more than 35%, there will be little effect as a release agent, and good fixing will not be achieved. If the dispersed average particle size is greater than 1.5 μm and if particles larger than 2.0 μm account for more than 5%, the dispersibility of the wax in the resin will decrease, and there will be only minimal reduction in toner repulsion caused by charge action. This also leads to more fogging and toner scattering.

When wax in the resin has a linear or oval structure, it is preferable for the major axis diameter to be from 0.5 to 3 μm, for particles smaller than 0.5 μm to account for no more than 35%, for particles of 0.5 to 3.5 μm to account for at least 65%, and for particles larger than 3.5 μm to account for no more than 5%. If the average diameter is less than 0.5 μm, and if particles smaller than 0.5 μm account for more than 35%, there will be little effect as a release agent, and good fixing will not be achieved. If the average diameter is greater than 3 μm, or if particles larger than 3.5 μm account for more than 5%, the dispersibility of the wax in the resin will decrease, and there will be only minimal reduction in toner repulsion caused by charge action. This also leads to more fogging and toner scattering. Also, handling in the developing unit will be more difficult, and developing memory characteristics deteriorate.

(3) Binder Resin

The binder resin in this embodiment preferably contains a polyester resin in which at least one molecular weight maximum peak is in a region of 2×10³ to 3×10⁴ in the GPC molecular weight distribution, the content of components in the high molecular weight region with a molecular weight of at least 3×10⁴ is at least 5% with respect to the entire binder resin, the weight average molecular weight is from 10,000 to 300,000, the Z average molecular weight is from 20,000 to 5,000,000, the ratio of the weight average molecular weight to the number average molecular weight (weight average molecular weight/number average molecular weight) is from 3 to 100, the ratio of the Z average molecular weight to the number average molecular weight (Z average molecular weight/number average molecular weight) is from 10 to 2000, the melting temperature as measured by the ½ method with a flow tester that was a constant load extrusion type of capillary rheometer (this temperature is hereinafter referred to as the softening point) is from 80 to 150° C., the flow beginning temperature is from 80 to 120° C., and the glass transition point of the resin is from 45 to 68° C. Even more preferably, the binder resin contains a polyester resin in which the weight average molecular weight is from 10,000 to 200,000, the Z average molecular weight is from 20,000 to 3,000,000, the weight average molecular weight/number average molecular weight is from 3 to 50, the Z average molecular weight/number average molecular weight is from 20 to 1000, the softening point is from 90 to 140° C., the flow beginning temperature is from 85 to 115° C., and the glass transition point is from 52 to 68° C.

More preferable still is for the binder resin to contain a polyester resin in which the weight average molecular weight is from 10,000 to 150,000, the Z average molecular weight is from 20,000 to 500,000, the weight average molecular weight/number average molecular weight is from 3 to 15, the Z average molecular weight/number average molecular weight is from 50 to 1000, the softening point is from 105 to 135° C., the flow beginning temperature is from 90 to 120° C., and the glass transition point is from 58 to 66° C.

The content of components in the high molecular weight region with a molecular weight of at least 1×10⁵ preferably is at least 3% with respect to the entire binder resin. Even more preferably, the content of components in the high molecular weight region with a molecular weight of at least 3×10⁵ preferably is at least 0.5% with respect to the entire binder resin.

Preferably, the content of components in the high molecular weight region with a molecular weight of from 8×10⁴ to 1×10⁷ is at least 3% with respect to the entire binder resin, and there is no component with a molecular weight of more than 1×10⁷.

Even more preferably, the content of components in the high molecular weight region with a molecular weight of from 3×10⁵ to 9×10⁶ is at least 1% with respect to the entire binder resin, and there is no component-with a molecular weight of more than 9×10⁶.

Even more preferably, the content of components in the high molecular weight region with a molecular weight of from 7×10⁵ to 6×10⁶ is at least 1% with respect to the entire binder resin, and there is no component with a molecular weight of more than 6×10⁶.

If the high molecular weight component content is too high, or if the molecules are too large, a high molecular weight component will remain behind in kneading and hinder optical transmissivity, and also will lower the efficiency at which the resin itself is manufactured. Also, this component can scratch the developing roller and supply roller and produce streaks in the image. The dispersibility of the wax also decreases.

If the weight average molecular weight of the binder resin is less than 10,000, or the Z average molecular weight is less than 20,000, or the weight average molecular weight/number average molecular weight is less than 3, or the Z average molecular weight/number average molecular weight is less than 10, or the softening point is lower than 80° C., or the flow beginning temperature is lower than 80° C., or the glass transition point is lower than 45° C., there will be a decrease in dispersibility during kneading, and this leads to more fogging and lower durability. Also, even though the kneading stress may be adequate during kneading, it will be impossible to keep the molecular weight at the proper level. The dispersibility of the wax or charge control agent in the resin will decrease, and there will be only minimal reduction in toner repulsion caused by charge action. This also leads to more fogging and toner scattering. Also, offset resistance and storage stability will decrease, the transfer member will not be properly cleaned, and filming will occur on the photosensitive member.

If the weight average molecular weight of the binder resin is greater than 300,000, or the Z average molecular weight is greater than 5,000,000, or the weight average molecular weight/number average molecular weight is greater than 100, or the Z average molecular weight/number average molecular weight is greater than 2000, or the softening point is higher than 150° C., or the flow beginning temperature is higher than 120° C., or the glass transition point is higher than 68° C., then the load on the machine during treatment may be excessive, which can lead to a drastic drop in productivity or to a decrease in optical transmissivity in a color image or a decrease in fixing strength.

Fixability will be enhanced further if the toner that has undergone melt kneading has a GPC molecular weight distribution in which there is at least one molecular weight maximum peak in the region of 2×10³ to 3×10⁴, and there is at least one molecular weight maximum peak or shoulder in the region of 5×10⁴ to 1×10⁶.

Preferably, at least one molecular weight maximum peak is located on the toner low molecular weight side in a range of 3×10³ to 2×10⁴, and even more preferably, in a range of 4×10³ to 2×10⁴.

Preferably, at least one molecular weight maximum peak or shoulder is located on the toner high molecular weight side in a range of 6×10⁴ to 7×10⁵, and even more preferably, in a range of 8×10⁴ to 5×10⁵.

If the molecular weight maximum peak location in the molecular weight distribution of the toner on the low molecular weight side is less than 2×10³, durability will decrease, but if this is greater than 3×10⁴, fixability and optical transmissivity will both decrease.

If the molecular weight maximum peak or shoulder location in the molecular weight distribution of the toner on the high molecular weight side is less than 5×10⁴, offset resistance will decrease, as will storage stability. Developability will also suffer, and there will be more fogging. If this is greater than 1×10⁶, though, pulverization will be difficult, which leads to a drop in productivity.

It is preferable for the content of the component located in the toner high molecular weight range with a high molecular weight of at least 5×10⁵ to be no more than 10 wt % with respect to the entire binder resin. If there is a large amount of component located in the high molecular weight range of at least 5×10⁵, or if the molecules are very large, this is a result of the fact that kneading stress is applied unevenly to the material constituting the toner during kneading, resulting in a poor state of kneading. This markedly impairs the optical transmissivity. Thus, poor dispersion results in more fogging, decreases transfer efficiency, makes the toner more difficult to pulverize, and lowers production efficiency.

More preferably, the content of the high molecular weight component of at least 5×10⁵ is no more than 5% with respect to the entire binder resin, and even more preferably, the content of the high molecular weight component of at least 1×10⁶ is no more than 1% with respect to the entire binder resin, or none at all is contained.

Also, in the molecular weight distribution in a toner GPC chromatogram, if we let Ha be the height of the molecular weight distribution of the molecular weight maximum peak located between 2×10³ and 3×10⁴, and Hb be the height of the molecular weight maximum peak or shoulder located between 5×10⁴ and 1×10⁶, then Hb/Ha is from 0.15 to 0.9.

If Hb/Ha is less than 0.15, there will be a decrease in both offset resistance and storage stability, resulting in increased filming on a developing roller and the photosensitive member. If the ratio is greater than 0.9, pulverization will be more difficult, productivity will decrease, and cost will rise. More preferably, Hb/Ha is from 0.15 to 0.7, and even more preferably, Hb/Ha is from 0.2 to 0.6.

In an arrangement in which, in the GPC molecular weight distribution of the toner, at least one molecular weight maximum peak is within the range of 2×10³ to 3×10⁴, and at least one molecular weight maximum peak or shoulder is within the range of 5×10⁴ to 1×10⁶, if we focus on the molecular weight curve within a region greater than the molecular weight value corresponding to the maximum peak or shoulder of the molecular weight distribution located within the molecular weight range of 5×10⁴ to 1×10⁶, and if we assume that the height of the maximum peak or shoulder in this molecular weight distribution is set to a base of 100%, and if we let M90 be the molecular weight corresponding to 90% of the height of the molecular weight maximum peak or shoulder, and M10 be the molecular weight corresponding to 10% of the height of the molecular weight maximum peak or shoulder, then setting M10/M90 to be from 0.5 to 0.8, and further setting (M10−M90)/M90 to be from 0.1 to 7, allows optical transmissivity to be ensured, and also allows oil-less fixing in which offset is prevented to be achieved without any fixing oil being required. This also suppresses the occurrence of toner-spent on the carrier and extends the service life of the developer. Specifying the value M10/M90, and further, the value (M10−M90)/M90 (the slope of the molecular weight distribution curve), makes it possible to quantify the state of molecular cleavage of the ultra-high molecular weight component, and if this value is within the range given above (which suggests that the slope of the molecular weight distribution curve is steep), cleavage during kneading eliminates the ultra-high molecular weight component which would hamper optical transmissivity, the result being good optical transmissivity. Moreover, the high molecular weight component that forms the peak or shoulder appearing on the high molecular weight side contributes to offset resistance, making it possible to prevent the occurrence of offset in colored toner without the use of any oil. This also suppresses the occurrence of toner-spent on the carrier and extends the service life of the developer. Furthermore, in the course of the molecular cleavage of the ultra-high molecular weight component, the wax and charge control agent can be dispersed uniformly in the binder resin, which makes the amount of charge more uniform, affords higher resolution, and allows durability to be maintained even over long-term continuous use. This also improves the cleaning of the transfer member, facilitates handling within the developing unit, and increases uniformity in toner density. The occurrence of developing memory also is suppressed. It is also possible to prevent partial transfer defects and image disruption during transfer, and consequently to achieve more efficient transfer. If the value of M10/M90 is greater than 8, or if (M10−M90)/M90 is more than 7, the ultra-high molecular weight component still remains, which hampers good optical transmissivity. If the value of M10/M90 is smaller than 0.5, or if (M10−M90)/M90 is less than 0.1, the mechanical load during kneading is too high and productivity will fall. This also lowers toner durability. Preferably, the value of M10/M90 is from 0.5 to 6, and (M10−M90)/M90 is from 0.1 to 4.5. More preferably, the value of M10/M90 is from 0.5 to 4.5, and (M10−M90)/M90 is from 0.1 to 3.5. This affords higher quality digital images and better color reproduction, prevents toner-spent on the carrier in two-component developing, and allows both optical transmissivity and offset resistance to be achieved without the use of an oil for preventing offset on the fixing roller. Furthermore, this realizes a cleaner process, shortens the transfer distance, prevents partial transfer defects in the transfer step of a high-speed tandem transfer process, and results in better transfer.

Characteristics that did not appear in the past can be attained by kneading under a high shearing force in the melt kneading of the above-mentioned binder resin. This affords both good optical transmissivity and offset resistance in a color toner in fixing without the use of an oil. That is, when a binder resin containing a ultra-high molecular weight component is subjected to high shearing force, this ultra-high molecular weight component is reduced in molecular weight, which results in higher optical transmissivity, and the presence of this ultra-high molecular weight component that has been reduced in molecular weight also provides satisfactory offset resistance. Also, since there is a ultra-high molecular weight component, high shearing force is produced during kneading, so that the wax can be dispersed more uniformly, optical transmissivity is improved, and good transfer can be accomplished, with no offset and with high image quality and high color reproduction. This also suppresses the occurrence of toner-spent to the carrier and extends the service life of the developer.

After the kneading process, the weight average molecular weight of the toner will be between 8000 and 180,000, the Z average molecular weight between 18,000 and 1,000,000, the ratio of weight average molecular weight to number average molecular weight (weight average molecular weight/number average molecular weight) between 3 and 80, and the ratio of Z average molecular weight to number average molecular weight (Z average molecular weight/number average molecular weight) between 10 and 1000. If a toner within is kneaded under a high shearing force to within these suitable ranges, both optical transmissivity and offset resistance can be achieved in a color toner in fixing without the use of an oil. Preferably, the weight average molecular weight is from 8000 to 100,000, the Z average molecular weight is from 18,000 to 300,000, the weight average molecular weight/number average molecular weight is from 3 to 60, and the Z average molecular weight/number average molecular weight is from 10 to 500. Even more preferably, the weight average molecular weight is from 10,000 to 40,000, the Z average molecular weight is from 20,000 to 80,000, the weight average molecular weight/number average molecular weight is from 3 to 30, and the Z average molecular weight/number average molecular weight is from 10 to 50. If the weight average molecular weight is less than 8000, or if the Z average molecular weight is less than 18,000, or if the weight average molecular weight/number average molecular weight is less than 3, or if the Z average molecular weight/number average molecular weight is less than 10, not enough kneading stress will be applied, and the molecular weight cannot be maintained at the proper level. Wax dispersibility will decrease, as well offset resistance and high temperature storage stability, cleaning of the intermediate transfer member will be poor, and filming will occur on the photosensitive member. On the other hand, if the weight average molecular weight is greater than 180,000, or if the Z average molecular weight is greater than 1,000,000, or if the weight average molecular weight/number average molecular weight is greater than 80, or if the Z average molecular weight/number average molecular weight is greater than 1000, the charge control agent and other internal additives will agglomerate together, leading to a drop in dispersibility, an increase in fogging, a decrease in image density, and poor transfer. This will also lead to a decrease in fixing strength, optical transmissivity, and gloss.

The binder resin is to contain no more than 5 wt % THF insolubles, and preferably contains no THF insolubles at all. If the THF insoluble content is over 5 wt %, the optical transmissivity of a color image will suffer and the image will be inferior.

A binder resin that can be used preferably in this embodiment is a polyester resin obtained by polycondensation of an alcohol component and a carboxylic acid component such as a carboxylic acid, carbonate, or carboxylic anhydride.

Examples of dicarboxylic acids or lower alkyl esters include aliphatic dibasic acids such as malonic acid, succinic acid, glutaric acid, adipic acid, and hexahydrophthalic anhydride, aliphatic unsaturated dibasic acids such as maleic acid, maleic anhydride, fumaric acid, itaconic acid, and citraconic acid, aromatic dibasic acids such as phthalic anhydride, phthalic acid, terephthalic acid, and isophthalic acid, and methyl esters and ethyl esters of these. Of these, an aromatic dibasic acid such as succinic acid, phthalic acid, terephthalic acid, or isophthalic acid, or a lower alkyl ester of one of these acids, is preferred. It is preferable to use a combination of succinic acid and terephthalic acid, or of phthalic acid and terephthalic acid.

Examples of trivalent and higher carboxylic acid components include 1,2,4-benzenetricarboxylic acid, 1,2,5-benzenetricarboxylic acid, 1,2,4-cyclohexanetricarboxylic acid, 2,5,7-naphtalenetricarboxylic acid, 1,2,4-naphtalenetricarboxylic acid, 1,2,4-butanetricarboxylic acid, 1,2,5-hexatricarboxylic acid, 1,3-dicarboxyl-2-methyl-2-methylenecarboxypropane, tetra(methylene carboxyl)methane, 1,2,7,8-octanetetracarboxylic acid, pyromellitic acid, Enpol trimer acid, and acid anhydrides and alkyl (C₁ to C₁₂) esters of these.

Examples of dihydric alcohols include diols such as ethylene glycol, 1,2-propylene glycol, 1,3-propylene glycol, 1,3-butylene glycol, 1,4-butylene glycol, 1,6-hexanediol, neopentyl glycol, diethylene glycol, dipropylene glycol, bisphenol A ethylene oxide adduct, and bisphenol A propylene oxide adduct, triols such as glycerol, trimethylolpropane, and trimethylolethane, and mixtures of these. Of these, a bisphenol A expressed by Chemical Formula 3, its derivatives, its alkylene oxide adducts, neopentyl glycol, or trimethylolpropane is particularly preferable.

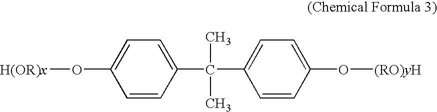

(Where R is an ethylene group or propylene group, x and y are each an integer greater than or equal to 1, and the average value of x+y is from 2 to 10.)

Examples of trihydric and higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

The polymerization can be performed by a known process, such as polycondensation or solution polycondensation. This allows a good toner to be obtained without sacrificing PVC matte resistance or the color of the coloring material used in a color toner. Polycarboxylic acids and polyhydric alcohols usually are used in a proportion such that the ratio of the number of hydroxyl groups to the number of carboxyl groups (OH/COOH) is from 0.8 to 1.4. The molecular weights of the resin, wax, and toner are measured by gel permeation chromatography (GPC) using a number of kinds of monodisperse polystyrene as the standard sample.

The apparatus used in this measurement is one from the HPLC 8120 series (made by Tosoh), with columns of TSKgel superHM-H H4000/H3000/H2000 (diameter: 7.8 mm, 150 mm×3), with an eluent of THF (tetrahydrofuran) at a flow rate of 0.6 mL/min, a sample concentration of 0.1%, and an added amount of 20 μL, with an RI detector, and at a measurement temperature of 40° C. As a pretreatment, the sample is dissolved in THF and filtered through a filter of 0.45 μm to remove additives such as silica. The resin component thus obtained is measured. The measurement conditions are such that the molecular weight distribution of the sample to be measured is included in a range in which a straight line is formed by the count number and the logarithm of the molecular weight in a calibration curve obtained from a plurality of different monodisperse polystyrene standard samples.

The apparatus used to measure the wax obtained by reacting a C₄ to C₃₀ long chain alkyl alcohol, an unsaturated polycarboxylic acid or anhydride thereof, and an unsaturated hydrocarbon wax is a GPC-15° C. made by Waters, with columns of Shodex HT-806M (8.0 mm I.D.−30 cm×2), with an eluent of o-dichlorobenzene at a flow rate of 1.0 mL/min, a sample concentration of 0.3%, and an added amount of 200 μL, with an RI detector, and at a measurement temperature of 130° C. As a pretreatment, the sample is dissolved in a solvent and then filtered through a sintered metal filter of 0.5 μm. The measurement conditions are such that the molecular weight distribution of the sample to be measured is included in a range in which a straight line is formed by the count number and the logarithm of the molecular weight in a calibration curve obtained from a plurality of different monodisperse polystyrene standard samples.

The softening point of the binder resin is measured as follows by using a constant load extrusion type capillary rheometer made by Shimadzu (CFT500). While heating 1 cm³ of sample at a temperature elevation rate of 6° C./min, a load of approximately 9.8×10⁵ N/m² is applied by a plunger to extrude the sample from a die 1 mm in diameter and 1 mm in length. Based on the relationship between the piston stroke of the plunger and the temperature elevation characteristics, the temperature at which the piston stroke starts to rise is termed the flow beginning temperature (Tfb), and one-half the difference between the lowest value on the curve and the flow end point is calculated, and the temperature at the point where the lowest value in the curve is added to the one-half value is termed the melting temperature (softening point Tm) by the ½ method.

The glass transition point of the resin is measured by using a differential scanning calorimeter, and refers to the temperature at the point of intersection between an extension of a base line below the glass transition point and a tangent having the maximum slope from the peak rise portion to the peak top, in the course of measuring hysteresis when the sample is heated to 100° C. and left at that temperature for 3 minutes, after which it is cooled to room temperature at a temperature decrease rate of 10° C./min, and then heated at a temperature elevation rate of 10° C./min.

The melting point in an endothermic peak (as determined by DSC) is measured with a differential scanning calorimeter DSC-50 made by Shimadzu. The sample is heated to 200° C. at a rate of 5° C./min, is held at that temperature for 5 minutes, and is quenched to 10° C., after which it is allowed to stand for 15 minutes, and then heated at a rate of 5° C./min, and the melting point is found from the endothermic (melting) peak. The amount of the sample put into a cell is 10 mg±2 mg.

Preferable examples of the binder resin used in this embodiment also include homopolymers or copolymers of various kinds of vinyl monomer. Examples include styrene and derivatives thereof, such as styrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-hexylstyrene, and p-chlorostyrene, with styrene being particularly preferable.

Examples of acrylic monomers include acrylic acid, methacrylic acid, methyl acrylate, ethyl acrylate, butyl acrylate, 2-ethylhexyl acrylate, cyclohexyl acrylate, phenyl acrylate, methyl methacrylate, hexyl methacrylate, 2-ethylhexyl methacrylate, beta-hydroxyethyl acrylate, gamma-hydroxypropyl acrylate, alpha-hydroxybutyl acrylate, beta-hydroxyethyl methacrylate, gamma-aminopropyl acrylate, gamma-N,N-diethylaminopropyl acrylate, ethylene glycol dimethacrylate, and tetraethylene glycol dimethacrylate. A copolymer of styrene and butyl acrylate is preferable as the styrene-acrylic copolymer for the purposes of the present invention, and particularly one that contains 75 to 85 wt % styrene and 15 to 25 wt % butyl acrylate.

(4) Charge Control Agent

A charge control agent is added in this embodiment for the purpose of controlling the toner charge and for ensuring stronger oil-less fixing. An acrylsulfonic acid-based polymer is a preferable material, and a vinyl copolymer of a styrene-based monomer and an acrylic acid-based monomer having sulfonic acid groups as polar groups is preferred. The characteristics will be particularly preferable with a copolymer of acrylamide-2-methylpropanesulfonic acid. When used in combination with the above-mentioned carrier, this facilitates handling within the developing unit, and increases uniformity in toner density. The occurrence of developing memory is also suppressed.

The metal salt of a salicylic acid derivative shown in Chemical Formula 4 can be used as a preferable material.

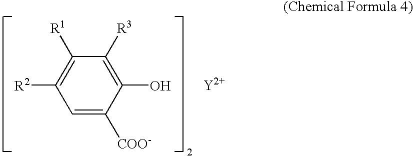

(Where R¹, R², and R³ are each independently a hydrogen atom or a linear or branched C₁ to C₁₀ alkyl group or allyl group, and Y is at least one element selected from among zinc, nickel, cobalt, copper, and chromium.)

The metal salt of a benzylic acid derivative shown in Chemical Formula 5 can be used as a preferable material.

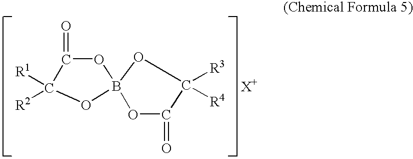

(Where R¹ and R⁴ are each independently a hydrogen atom, a linear or branched C₁ to C₁₀ alkyl group, or an aromatic group that may have a substituent, R² and R³ are aromatic rings that may be substituted, and X is an alkali metal.)

This constitution ensures a wide range of non-offset temperature in oil-less fixing, and also prevents image disruption caused by a charge action during fixing. This is believed to be the effect of the charge polarity of the metal salt and functional group having an acid value possessed by the wax. This also reduces the amount of charge in continuous use.

The added amount of this agent is preferable from 0.5 to 5 parts by weight per 100 parts by weight binder resin. 1 to 4 parts by weight is even more preferable, and 3 to 4 parts by weight is better yet. There will be no charge action effect if the amount is less than 0.5 parts by weight, but color impurity will be pronounced in a color image if the amount is greater than 5 parts by weight.

(5) Pigment

Examples of the pigment used in this embodiment include carbon black, iron black, graphite, nigrosine, a metal complex of an azo dye, arylamide acetoacetate monoazo yellow pigments such as C.I. pigment yellow 1, 3, 74, 97, and 98, arylamide acetoacetate diazo yellow pigments such as C.I. pigment yellow 12, 13, 14, and 17, C.I. solvent yellow 19, 77, and 79, and C.I. disperse yellow 164. A benzimidazolone-based pigment such as C.I. pigment yellow 93, 180, or 185 is particularly preferable.

One or more types of red pigment such as C.I. pigment red 48, 49:1, 53:1, 57, 57:1, 81, 122, and 5, red dyes such as C.I. solvent red 49, 52, 58, and 8, and blue dyes or pigments such as phthalocyanine or a derivative thereof, such as C.I. pigment blue 15:3 are added. The added amount preferably is from 3 to 8 parts by weight per 100 parts by weight binder resin.

(6) External Additives

The additive in this embodiment is an externally added micropowder produced by treating a fatty acid or the like, which results in excellent partability between the photosensitive member and any toner adhering to the photosensitive member. Furthermore, a treatment that involves a combination with polysiloxane makes the toner charge distribution more uniform, which results in fewer partial transfer defects and prevents back transfer. As a result, partial transfer defects and back transfer can be prevented even with a toner that has become more cohesive through the addition of a certain amount of wax for the sake of oil-less fixing. Also, when used in combination with the carrier (discussed below) or wax, this results in excellent partability, toner-spent resistance can be enhanced further by the better uniformity in toner charge distribution resulting from treatment with polysiloxane, handling within the developing unit is facilitated, and the uniformity of toner density is increased. The occurrence of developing memory also can be suppressed. Furthermore, filming on the photosensitive member can be prevented and fusion to the fixing and heating member can be prevented. Also, both good transfer and oil-less fixing can be achieved even with a toner of smaller particle size. Latent images can be reproduced more faithfully in developing. Also, a greater proportion of the toner particles can be transferred. Further, retransfer can be prevented in tandem transfer, and the occurrence of partial transfer defects can be suppressed. In addition, a high image density can be obtained even when the amount of developer is decreased.

Examples of additives include metal oxide micropowders such as silica, alumina, titanium oxide, zirconia, magnesia, ferrite, and magnetite, titanates such as barium titanate, calcium titanate, and strontium titanate, zirconates such as barium zirconate, calcium zirconate, and strontium zirconate, and mixtures of these. The additive can be subjected to a hydrophobic treatment as needed. Compounds expressed by the Sixth Chemical Formula are preferable as silicone oil-based materials used to treat silica.

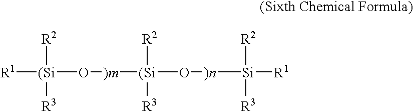

(Where R² is a C₁ to C₃ alkyl group, R³ is a C₁ to C₃ alkyl group, halogen-modified alkyl group, phenyl group, or substituted phenyl group, R¹ is a C₁ to C₃ alkyl group or C₁ to C₃ alkoxy group, and m and n are integers of at least 1 and no more than 100.)

For example, it is preferable to use a silica that has been treated with one or more of the following: dimethyl silicone oil, methyl hydrogen silicone oil, methyl phenyl silicone oil, cyclic dimethyl silicone oil, epoxy-modified silicone oil, carboxyl-modified silicone oil, carbinol-modified silicone oil, methacrylic-modified silicone oil, mercapto-modified silicone oil, polyether-modified silicone oil, methyl styryl-modified silicone oil, alkyl-modified silicone oil, fluorine-modified silicone oil, amino-modified silicone oil, and chlorophenyl-modified silicone oil. Examples include SH200, SH510, SF230, SH203, BY16-823, BY16-855B, and other such products of Toray-Dow Corning.

Treatment methods include a method in which an inorganic micropowder and a silicone oil or other such material are mixed with a mixer such as a Henschel mixer, a method in which a silicone oil material is sprayed onto silica, and a method in which a silicone oil material is dissolved or dispersed in a solvent, then mixed with a silica micropowder, and the solvent is then removed. The silicone oil material preferably is contained in an amount of 0.1 to 30 parts by weight per 100 parts by weight inorganic micropowder.

Examples of silane coupling agents include dimethyldichlorosilane, trimethylchlorosilane, allyldimethylchlorosilane, hexamethyldisilazane, allylphenyldichlorosilane, benzilmethylchlorosilane, vinyltriethoxysilane, gamma-methacryloxypropyltrimethoxysilane, vinyltriacetoxysilane, divinylchlorosilane, and dimethylvinylchlorosilane. The silane coupling agent treatment involves, for example, a dry treatment in which the micropowder is stirred or otherwise put into a cloud state, and this is reacted with a vaporized silane coupling agent, or a wet treatment in which a silane coupling agent dispersed in a solvent is drip-reacted with a micropowder. It is also preferable to treat the silicone oil material after the silane coupling treatment. An inorganic micropowder that is positively chargeable is treated with aminosilane or with an epoxy-modified silicone oil or an amino-modified silicone oil expressed by Chemical Formula 7.

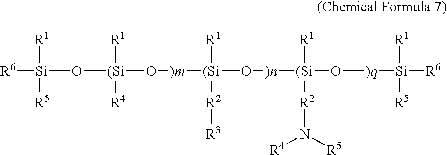

(Where R¹ and R⁶ are each a hydrogen atom, C₁ to C₃ alkyl group, alkoxy group, or aryl group, R² is a C₁ to C₃ alkylene group or phenylene group, R³ is an organic group including a nitrogen hetero ring, R⁴ and R⁵ are each a hydrogen atom, C₁ to C₃ alkyl group, or aryl group, m is a number greater than or equal to 1, n and q are positive integers including zero, and n+1 is a positive number greater than or equal to 1.)

In order to enhance the effect of the hydrophobic treatment, it is preferable to perform an additional treatment with hexamethyldisilazane, dimethyldichlorosilane, or another silicone oil. For example, it is preferable to perform the treatment with at least one of dimethyl silicone oil, methylphenyl silicone oil, and alkyl-modified silicone oil.

The use of an inorganic micropowder that has been treated with a fatty acid ester, fatty acid amide, or fatty acid metal salt is also preferable. Even better is a silica or titanium oxide micropowder that has been surface treated with one or more of these.

Examples of fatty acids and fatty acid metal salts that can be used for the surface treatment of an inorganic micropowder include caprylic acid, capric acid, undecylic acid, lauric acid, myristic acid, palmitic acid, stearic acid, behenic acid, montanic acid, lacceric acid, oleic acid, erucic acid, sorbic acid, and linoleic acid. Of these, a fatty acid with a carbon number of 15 to 20 is preferred. Examples of the metal that constitutes the fatty acid metal salt include aluminum, zinc, calcium, magnesium, lithium, sodium, lead, and barium. Of these, aluminum, zinc, and sodium are preferred. Particularly preferable are aluminum salts of difatty acids such as aluminum distearate (Al(OH)(C₁₇H₃₅COO)₂) and aluminum salts of monofatty acids such as aluminum monostearate (Al(OH)₂(C₁₇H₃₅COO)). Having OH groups prevents excess charging and keeps transfer defects to a minimum. This also seems to improve treatability with silica and other such inorganic micropowders during treatment.

The surface treatment is performed by dissolving one of the above fatty acids in an aromatic solvent, wet mixing or spraying this solution along with silica, titanium oxide, alumina, or another such micropowder to effect a stirring treatment, causing the fatty acid to adhere to or react with the surface of the micropowder, and thereby effecting a surface treatment, after which this product is dried and the solvent is removed. The treatment amount here preferably is from 0.1 to 25 parts by weight per 100 parts by weight inorganic micropowder matrix. If the amount is less than 0.1 parts by weight, the treatment agent will not sufficiently exhibit its function. Over 25 parts by weight, however, there will be so much free fatty acid that it will adversely affect developing and durability.

In a preferred embodiment, the surface of the inorganic micropowder preferably is treated with a fatty acid and/or fatty acid metal salt after it first has been treated with a coupling agent and/or silicone oil. This is because a more uniform treatment is possible than when hydrophilic silica is merely treated with a fatty acid, and a higher toner charge is attained, and fluidity is higher when the powder is added to the toner. It is also possible to treat with a fatty acid and/or fatty acid metal salt along with a coupling agent and/or silicone oil, in which case the effect will be the same as above.

Handling of the toner particles can be facilitated, and both higher image quality and better transfer can be achieved in developing and transfer with microparticles by adjusting the composition of the additives. Latent images can be more faithfully reproduced in developing. Also, a greater proportion of the toner particles can be transferred. Further, retransfer can be prevented in tandem transfer, and the occurrence of partial transfer defects can be suppressed. In addition, a high image density can be obtained even when the amount of developer is decreased. Furthermore, if this is used in combination with the above-mentioned carrier or wax, toner-spent resistance will be improved, handling in the developing unit will be facilitated, and there will be better uniformity of toner density. This also reduces the occurrence of developing memory.

It is preferable for an inorganic micropowder with an average particle size of 6 to 120 nm to be externally added in an amount of 1.0 to 5.5 parts by weight per 100 parts by weight of a toner matrix. If the average particle size is less than 6 nm, filming will tend to occur on the photosensitive member, and there will tend to be suspended silica. Also, back-transfer cannot be eliminated completely during transfer. Toner fluidity will decrease, though, if the size is over 120 nm. If the amount is under 1.0 parts by weight, toner fluidity will decrease and back-transfer cannot be completely eliminated during transfer. Silica suspension and filming on the photosensitive member will tend to occur if the amount is over 5.5 parts by weight.

Another preferable constitution is one in which at least an inorganic micropowder with an average particle size of 6 to 20 nm is externally added in an amount of 0.5 to 2 parts by weight per 100 parts by weight of toner matrix particles, and an inorganic micropowder with an average particle size of 30 to 120 nm is externally added in an amount of 0.5 to 3.5 parts by weight per 100 parts by weight of toner matrix particles. The use of a silica whose functions have been separated as in this constitution affords a wider margin with respect to scattering, partial transfer defects, back-transfer, and handling in developing. This also prevents toner-spent on the carrier. Outside the above ranges, however, this margin is narrowed, requiring higher precision on the machine side.

Yet another preferable constitution is one in which at least an inorganic micropowder with an average particle size of 6 to 20 nm and an ignition loss of 0.5 to 25 wt % is added externally in an amount of 0.5 to 2 parts by weight per 100 parts by weight of toner matrix particles, and an inorganic micropowder with an average particle size of 30 to 120 nm and an ignition loss of 0.1 to 23 wt % is externally added in an amount of 0.5 to 3.5 parts by weight per 100 parts by weight of a toner matrix particles.

Specifying the ignition loss of the silica affords a wider margin with respect to scattering, partial transfer defects, and back-transfer. Also, when used in combination with the above-mentioned carrier or wax, this increases toner-spent resistance, facilitates handling within the developing unit, and increases uniformity in toner density. The occurrence of developing memory also is suppressed. Outside the above range, however, this margin is narrowed, requiring higher precision on the machine side. In particular, the parting action during transfer can be stabilized and the transfer margin with respect to back-transfer and partial transfer defects can be stabilized. The transfer margin with respect to back-transfer and partial transfer defects will be narrower if the ignition loss is under 0.5 wt % with particles having an average size of 6 to 20 nm. The surface treatment will be uneven and there will be variance in charging if the ignition loss is over 25 wt %. Preferably, the ignition loss is from 1.5 to 20 wt %, and even more preferably from 5 to 19 wt %. The transfer margin with respect to back-transfer and partial transfer defects will be narrower if the ignition loss is under 0.1 wt % with particles having an average size of 30 to 120 nm. The surface treatment will be uneven and there will be variance in charging if the ignition loss is over 23 wt %. Preferably, the ignition loss is from 1.5 to 18 wt %, and even more preferably from 5 to 16 wt %.

Yet another preferable constitution is one in which at least a negatively-chargeable inorganic micropowder with an average particle size of 6 to 120 nm and an ignition loss of 0.5 to 25 wt % is externally added in an amount of 0.8 to 4 parts by weight per 100 parts by weight of toner matrix particles, and a positively-chargeable inorganic micropowder with an average particle size of 6 to 120 nm and an ignition loss of 0.5 to 25 wt % is externally added in an amount of 0.2 to 1.5 parts by weight per 100 parts by weight of a toner matrix particles.

The effect of adding a positively-chargeable inorganic micropowder is that it suppresses excess charging when the toner is used continuously for an extended period, which further extends the service life of the developer. Another effect is that during transfer it suppresses scattering caused by excess charging. It also prevents toner-spent on the carrier. The effect will be minimal if the amount is less than 0.2 parts by weight, but there will be an increase in fogging during developing if the amount is over 1.5 parts by weight. The ignition loss preferably is from 1.5 to 20 wt %, and even more preferably from 5 to 19 wt %.

Yet another preferable constitution is one in which at least a negatively-chargeable inorganic micropowder with an average particle size of 6 to 20 nm and an ignition loss of 0.5 to 25 wt % is added externally in an amount of 0.6 to 2 parts by weight per 100 parts by weight of toner matrix particles, a negatively-chargeable inorganic micropowder with an average particle size of 30 to 120 nm and an ignition loss of 0.1 to 23 wt % is added externally in an amount of 0.2 to 2.0 parts by weight per 100 parts by weight of toner matrix particles, and a positively-chargeable inorganic micropowder with an average particle size of 6 to 20 nm and an ignition loss of 0.5 to 25 wt % is added externally in an amount of 0.2 to 1.5 parts by weight per 100 parts by weight of a toner matrix particles.

The use of a negatively-chargeable inorganic micropowder (such as silica) whose functions have been separated as in this constitution affords a wider margin with respect to scattering, partial transfer defects, back-transfer, and handling in developing. This also prevents toner-spent on the carrier. Outside the above ranges, however, this margin is narrowed, requiring higher precision on the machine side. Furthermore, adding a positively-chargeable inorganic micropowder of 6 to 20 nm suppresses excess charging when the toner is used continuously for an extended period, and this further extends the service life of the developer. Another effect is that during transfer it suppresses scattering caused by excess charging. Handling in developing is stabilized, and this has the effect of stabilizing the service life. The ignition loss of the inorganic micropowder of 6 to 20 nm preferably is 1.5 to 20 wt %, and even more preferably 5 to 19 wt %. The ignition loss of the inorganic micropowder of 30 to 120 nm preferably is 1.5 to 18 wt %, and even more preferably 5 to 16 wt %.

Yet another preferable constitution is one in which at least a negatively-chargeable inorganic micropowder with an average particle size of 6 to 20 nm and an ignition loss of 0.5 to 25 wt % is externally added in an amount of 0.6 to 2 parts by weight per 100 parts by weight of toner matrix particles, a negatively-chargeable inorganic micropowder with an average particle size of 30 to 120 nm and an ignition loss of 0.1 to 23 wt % is externally added in an amount of 0.2 to 2.0 parts by weight per 100 parts by weight of toner matrix particles, and a positively-chargeable inorganic micropowder with an average particle size of 30 to 120 nm and an ignition loss of 0.1 to 23 wt % is externally added in an amount of 0.2 to 1.5 parts by weight per 100 parts by weight of a toner matrix particles. The use of a positively-chargeable inorganic micropowder of 30 to 120 nm stabilizes the service life and at the same time prevents partial transfer defects and back-transfer. The ignition loss of the inorganic micropowder of 6 to 20 nm preferably is 1.5 to 20 wt %, and even more preferably 5 to 19 wt %. The ignition loss of the inorganic micropowder of 30 to 120 nm preferably is 1.5 to 18 wt %, and even more preferably 5 to 16 wt %.

The drying loss (%) is found as follows. Approximately 1 g of sample is weighed out precisely in a vessel that has been dried, allowed to cool, and precisely weighed. The sample is dried for 2 hours with a hot forced air drier (105° C.±1° C.), then allowed to cool for 30 minutes in a desiccator, after which it is precisely weighed, and the drying loss is calculated from the following equation.
Drying loss (%)=weight loss on drying (g)÷amount of sample (g)×100

The ignition loss (%) is found as follows. Approximately 1 g of sample is placed in a magnetic crucible that has been dried, allowed to cool, and precisely weighed. The sample is ignited for 2 hours in an electric furnace set to 500° C., then allowed to cool for 1 hour in a desiccator, after which it is precisely weighed, and the ignition loss is calculated from the following equation.
Ignition loss (%)=weight loss on ignition (g)+amount of sample (g)×100

The moisture adsorption of the treated inorganic micropowder preferably is no more than 1 wt %, with 0.5 wt % or less being more preferable, 0.1 wt % or less even more preferable, and 0.05 wt % or less better yet. If the amount is more than 1 wt %, there will be a decrease in chargeability and filming will occur on the photosensitive member over time. The moisture adsorption apparatus used to measure the amount of moisture adsorption was a continuous evaporation and adsorption apparatus (Belsorp 18, made by BEL Japan).

The degree of hydrophobicity is measured as follows. 0.2 g of product to be tested is precisely weighed out in 50 mL of distilled water that has been poured into a 250 mL beaker. Methanol is dripped onto the distal end from a burette immersed in liquid, until the entire amount of inorganic micropowder is wetted. The system is intermittently and gently stirred with an electromagnetic stirrer during this time. The hydrophobicity is calculated with the following equation from the amount of methanol a (ml) needed to completely wet the powder.
Hydrophobicity=(a/(50+a))×100 (%)
(7) Powder Properties of Toner

The constitution in this embodiment is such that the volume average particle size of a toner containing at least a binder resin, a colorant, and a wax is from 3.5 to 6.5 μm, the toner contains from 30 to 80% particles (in the number distribution) of 5.04 μm or smaller, contains from 5 to 35% particles (in the number distribution) of 3.17 μm or smaller, and contains no more than 35 vol % particles whose size is between 6.35 and 10.1 μm.

In a more preferred embodiment, the volume average particle size of a toner containing at least a binder resin, a colorant, and a wax is from 3.5 to 6.5 μm, the toner contains from 30 to 80% particles (in the number distribution) of 5.04 μm or smaller, contains from 5 to 35% particles (in the number distribution) of 3.17 μm or smaller, contains no more than 30 vol% particles whose size is between 6.35 and 10.1 μm, and contains no more than 5 vol% particles of 8 μm or larger in the number distribution.

This affords an image of high resolution, prevents back-transfer in tandem transfer, prevents partial transfer defects, and allows oil-less fixing.

Good image quality and good transfer both cannot be attained if the volume average particle size is greater than 6.5 μm, but the toner particles will be difficult to handle in developing if the volume average particle size is less than 3.5 μm. Good image quality and good transfer both cannot be attained if the content of particles of 5.04 μm or smaller in the number distribution is less than 30%, but the toner particles will be difficult to handle in developing if the content is over 80%. Carrier fouling will also occur. Good image quality and good transfer both cannot be attained if the content of particles of 3.17 μm or smaller in the number distribution is less than 5%, but the toner particles will be difficult to handle in developing if the content is over 35%. Good image quality and good transfer both cannot be attained if toner particles having a size of 6.35 to 10.1 μm account for more than 35 vol %.

Furthermore, good image quality and good transfer both cannot be attained if toner particles having a size of 6.35 to 10.1 μm account for more 30 vol % and the content of particles of 8 μm or larger in the number distribution is greater than 5 vol %.

This constitution is such that the ratio SSt of the specific surface area St corresponding to a true sphere calculated from the volume average particle size (St=6/(true specific gravity×volume average particle size)) to the measured specific surface area of the produced toner matrix (SSt =St/(specific surface area of pulverized toner)) is from 0.4 to 0.95. This ratio preferably is from 0.5 to 0.85, and even more preferably from 0.55 to 0.8. The particles will be close to spherical if the ratio is over 0.95, which leads to a decrease in chargeability during continuous use, and to problems such as scattering during transfer. If the ratio is smaller than 0.4, the particles will be too amorphous in shape, or there will be too much excessively pulverized micropowder.

The coefficient of variation of the volume particle size distribution of the toner preferably is from 16 to 32%, and the coefficient of variation of the number particle size distribution preferably is from 18 to 35%. More preferably, the coefficient of variation of the volume particle size distribution is from 18 to 24%, and the coefficient of variation of the number particle size distribution is from 20 to 26%. Most preferably, the coefficient of variation of the volume particle size distribution is from 18 to 22%, and the coefficient of variation of the number particle size distribution is from 20 to 24%.

The coefficient of variation is a value obtained by dividing the standard deviation of the toner particle size by the average particle size. This value is found on the basis of particle sizes measured with a Coulter Counter (made by Coulter). The standard deviation is expressed as the square root of the value obtained by measuring n-number of particle systems and dividing the sum of the squares of the difference of the various measured values from the average value by (n−1). That is, the coefficient of variation expresses how wide the particle size distribution is, and when the coefficient of variation of the volume particle size distribution is less than 16%, or when the coefficient of variation of the number particle size distribution is less than 18%, manufacture becomes difficult and costs rise. When the coefficient of variation of the volume particle size distribution is greater than 32%, or when the coefficient of variation of the number particle size distribution is greater than 35%, the particle size distribution becomes broader, causing strong toner agglomeration, filming on the photosensitive member, and transfer defects, and making it difficult to recover residual toner in a cleaner-less process.

The micropowder in a toner affects the fluidity of the toner, image quality, storage stability, filming of the photosensitive member, the developing roller, and the transfer member, characteristics over time, transferability, and especially multilayer transferability in tandem transfer. It also affects optical transmissivity, gloss, and offset resistance in oil-less fixing. With a toner containing a wax or other release agent for the sake of oil-less fixing, the amount of micropowder affects tandem transferability.

If the amount of micropowder is too large, much wax that cannot be dispersed will be exposed on the toner surface, resulting in filming on the photosensitive member and transfer member. Furthermore, since a micropowder readily adheres to a hot roller, it tends to cause offset. Also, in tandem transfer, toner agglomeration tends to be strong, and this tends to result in transfer defects in the second color during multilayer transfer. If the amount of micropowder is too small, though, this can lead to a decrease in image quality.

The particle size distribution is measured with a Coulter Counter model TA-II (made by Coulter), and is measured by connecting to a computer and an interface (made by Nikkaki) that outputs the number distribution and volume distribution. About 2 mg of toner sample is added to about 50 mL of electrolyte to which a surfactant (sodium laurylsulfate) has been added in a concentration of 1%, and the electrolyte in which the sample has been suspended is subjected to a dispersal treatment for about 3 minutes with an ultrasonic disperser. An aperture of 70 μm was used with the Coulter Counter model TA-II. With an aperture of 70 μm, the particle size distribution measurement range is from 1.26 to 50.8 μm, but the region below 2.0 μm is impractical because external noise and so forth result in low measurement precision and reproducibility. Thus, the measurement range was set at 2.0 to 50.8 μm.

Compression, which is calculated from static bulk density and dynamic bulk density, is an index of toner fluidity. The fluidity of a toner is affected by the particle size distribution of the toner, the toner particle shape, additives, and the type and amount of wax. Compression is low and toner fluidity is high when the particle size distribution of the toner is narrow and there is little micropowder, or when there are few bumps on the surface of the toner and the particle shape is close to spherical, or when a large quantity of additives are added, or when the particle size of the additives is small. Compression preferably is from 5 to 40%, and even more preferably 10 to 30%. This allows both oil-less fixing and tandem multilayer transfer to be achieved. If the compression is less than 5%, fixability will decrease, and optical transmissivity will tend to be particularly poor. There will also tend to be more toner scattering from the developing roller. If the compression is greater than 40%, though, transferability will decrease, and partial transfer defects and the like will occur in tandem transfer.

(8) Kneading

Kneading under a high shearing force allows the added wax to be more finely dispersed. Thorough dispersion can be accomplished by optimally setting the kneading conditions, including the roll temperature, temperature gradient, rotational speed, and load current, and the softening point and glass transition point of the binder resin. “High shearing force” refers to a kneading force that acts on a binder resin or other toner material when rolls that are spaced at a narrow gap are rotated at high speed, and refers to the force produced when the material is squeezed through the narrow gap, and to the shearing force imparted by rotating rolls having a rotational speed differential. A kneading force is produced that was unattainable with a conventional biaxial extruder. This makes it possible to produce high and low molecular weight components for the binder resin.

More specifically, there are two opposing rolls that are rotating in different directions and are capable of heating or cooling. A temperature differential is provided between the temperature of one roll (RL1) and the other roll (RL2). The roll (RL1) and the roll (RL2) are rotated at different peripheral speeds so that kneading is performed between the two rolls. Furthermore, the roll (RL1) has a temperature differential between its front and rear portions.

The speed ratio of the two rolls is from 1.1 times to 2.5 times so that an appropriate shearing force is generated during kneading, the binder resin undergoes molecular cleavage, there is an increase in the dispersibility of the colorant and other internal additives, and developing and fixing are improved. This constitution is such that the roll on which the heated and melted toner is adheres has a higher rotation ratio. If the ratio is less than 1.1, the proper shearing force will not be produced, dispersibility will not be increased, and optical transmissivity will suffer. Conversely, if the ratio is over 2.5 times, there will be a sharp reduction in productivity, dispersibility will not increase, and developing will suffer.

If the kneading here is performed such that the ratio of load current values applied to the two rolls is between 1.25 and 10, the appropriate shearing force will be applied and the dispersibility of the internal additives will be improved. If the ratio is below this range, there will be no increase in dispersibility and optical transmissivity will suffer. Productivity will also decrease. Conversely, if the ratio is over this range, the rollers will be subjected to excessive load, and too much ultra-high molecular weight component will be further lowered in molecular weight, with the result being a decrease in offset resistance, so that offset will occur.

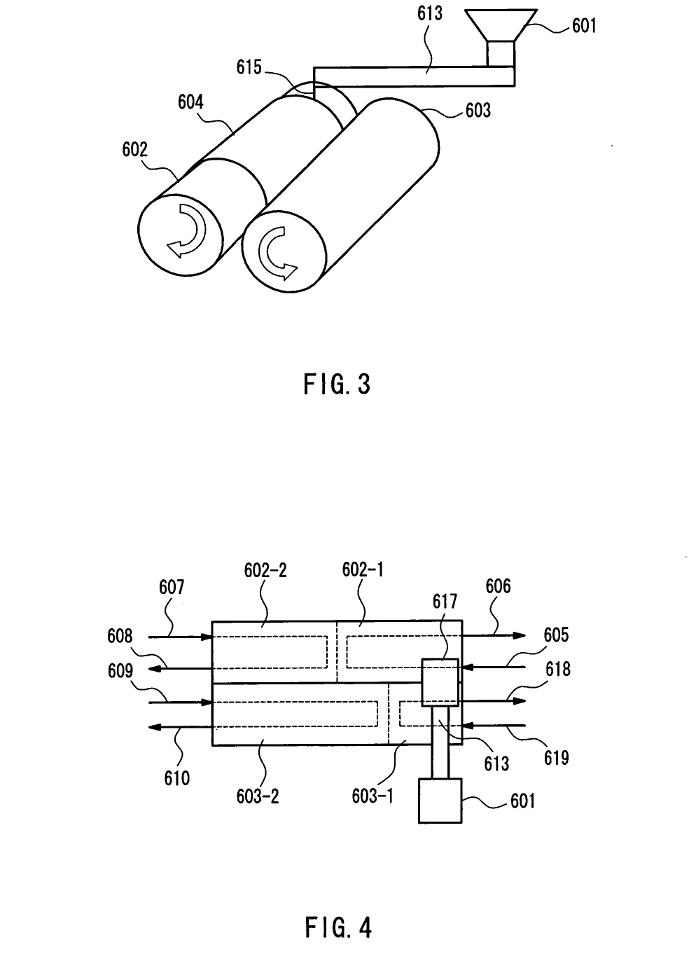

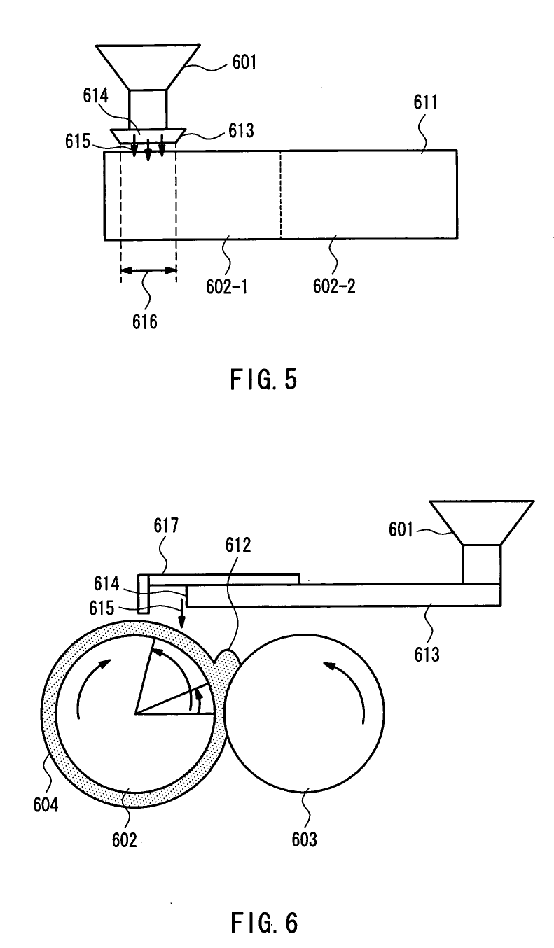

FIG. 3 is a simplified oblique view of a toner melt-kneading process, FIG. 4 is a plan view, FIG. 5 is a side view seen from the left side, and FIG. 6 is a cross section in a wound state. 601 is a metering supply unit for toner raw material, 602 is a roll (RL1), 603 is a roll (RL2), and 604 is a molten toner film adhering around the roll (RL1). The roll 602 rotates clockwise in FIG. 3, while the roll 603 rotates counterclockwise. In FIG. 4, 602-1 is the front half of the roll (RL1) (the upstream part in the direction of raw material conveyance), 602-2 is the rear half of the roll (RL1) (the downstream part in the direction of raw material conveyance), 603-1 is the front half of the roll (RL2) (the upstream part in the direction of raw material conveyance), 603-2 is the rear half of the roll (RL2) (the downstream part in the direction of raw material conveyance), 605 is an inlet for a heating medium for heating the front half 602-1 of the roll (RL1), 606 is an outlet for the heating medium that has heated the front half 602-1 of the roll (RL1), 607 is an inlet for a medium for heating or cooling the rear half 602-2 of the roll (RL1), 608 is an outlet for the medium that has heated or cooled the rear half 602-2 of the roll (RL1), 618 is an inlet for a medium for heating the front half 603-1 of the roll (RL2), 619 is an outlet for the heating medium that has heated the front half 603-1 of the roll (RL2), 609 is an inlet for a medium for heating or cooling the rear half 603-2 of the roll (RL2), and 610 is an outlet for the medium that has heated or cooled the rear half 603-2 of the roll (RL2). In FIG. 5, 611 is a spiral groove formed on the roll surface, the depth of which is about 2 to 10 mm. The spiral groove 611 is preferable for smoothly conveying the material from the right end of a material charging section to the left end of a discharge section during the kneading of the toner. 603-1 applies enough heat for the raw material to adhere efficiently around the roll. The raw material discharged from the metering supply unit 601 falls through an opening 614 into the vicinity of the end on the roll (RL1) 602-1 side while going through a raw material supply feeder 613, as shown by arrow 615. 616 represents the length of the opening of the supplying feeder. This length preferably is equal to from one-half to four times the roll radius. If the length is too short, there will be a rapid increase in the amount of material that drops down from the gap between the two rollers before it has been melted. If the length is too great, the material will separate in the midst of being conveyed by the raw material feeder, so that uniform dispersion will not be obtained.

In FIG. 6, the dropping position is set to a point within a range of 20 to 80 degrees from the point at which the two rolls of the roll (RL1) 602 are closest to each other, as indicated by the arrow. If the angle is less than 20 degrees, there will be a rapid increase the amount of the material dropping through the gap between the two rolls. If the angle is greater than 80 degrees, however, there will be more billowing of toner powder while it is being dropped, and this powder will foul the surrounding area. A cover 617 is provided so as to cover an area wider than the length of the opening portion 616. The cover is not depicted in FIG. 5.

The toner raw material from the metering supply unit 601 falls through the opening 614 while going through the raw material supply feeder 613. The toner raw material that has fallen is charged in the vicinity of the end on the roll (RL1) 602-1 side. The resin is melted by the heat of the roll (RL1) 602-1 and the compressive shearing force of the roll (RL2) 603-1, and adheres around the front half 602-1 of the roll (RL1). A toner pool 612 is formed between the rolls. This state spreads to the end of the rear half 602-2 of the roll (RL1), and the toner separates in a solid piece from the rear half 602-2 of the roll (RL2) that has been heated or cooled at a temperature lower than that of the front half 602-1 of the roll (RL1). During this process, the roll 603-2 is cooled to room temperature or lower. The clearance between the roll (RL1) 602 and the roll (RL2) 603 is from 0.1 to 0.9 mm. In this example, the raw material charge was 10 kg/h, the diameter of the rolls RL1 and RL2 was 140 mm, the length was 800 mm.

(9) Pulverization

The two-component developer pertaining to this embodiment prevents toner-spent on the carrier and allows oil-less fixing even when toner with a small particle size is used.

The following is an example of how this pulverization is accomplished. To achieve a small particle size and a sharp particle size distribution, the toner composition is melt kneaded, after which it is pulverized to the required particle size distribution with a pulverizer equipped with a cylindrical rotor that has a bumpy surface and rotate at high speed, a cylindrical stator that has a bumpy surface and shares its central axis with the rotor and is disposed on the outside of the rotor with a gap of 0.5 to 40 mm therebetween, a supply inlet through which the toner to be pulverized flows, and a discharge outlet for discharging the pulverized toner. The constitution here is such that some means is provided for lessening the agglomeration of the toner to be pulverized before this toner flows through the supply inlet, and the toner flows through the supply inlet and is pulverized to the required particle size distribution.

The purpose of the means for lessening the agglomeration of the toner to be pulverized is to allow the charge to be removed from the powder with an evaporative medium such as water vapor, ethanol, iso-propyl alcohol, n-butyl alcohol, sec-butyl alcohol, or iso-butyl alcohol, before the toner to be pulverized flows through the supply inlet. The toner to be pulverized is allowed to flow through the supply inlet after being made to adhere or mixed by being sprayed in the form of a mist.

Also, in a method in which the toner to be pulverized is subjected to a vibration means before flowing through the supply inlet, examples of the vibration means include ultrasonic vibration and mechanical vibration. A vibration apparatus is provided to the piping before the toner to be pulverized passes through the pipe and flows through the supply inlet of the pulverizing section, and the toner to be pulverized is dispersed while flowing through the supply inlet.

Another method is to supply and mix an inorganic micropowder into the toner to be pulverized before the toner flows through the supply inlet, and then allow the toner to flow through the supply inlet and be pulverized. One of the materials discussed above is suitable as this inorganic micropowder. In the pulverization of the toner, the constitution is such that an inorganic micropowder is supplied to and mixed with the toner to be pulverized before the toner flows through the supply inlet, and then the toner is allowed to flow through the supply inlet and is pulverized to the required particle size distribution. As a result, the toner to be pulverized is in a uniformly dispersed state when it enters the pulverizing section having the rotor, and the toner is uniformly pulverized by the eddy produced by the rotor. This makes possible pulverization to a small particle size, and pulverization in a state in which the raw powder has been sharply cut. The inorganic micropowder that is mixed in here preferably is a silica or titanium oxide micropowder that has an average particle size of 8 to 40 μm and an ignition loss of 0.5 to 25 wt %. The use of a silica or titanium oxide micropowder that has been surface treated with one or more of a fatty acid ester, fatty acid amide, and fatty acid metal salt is preferred. A silica or titanium oxide micropowder that has been surface treated with a silicone oil is an even more preferable material for the inorganic micropowder. Also, an inorganic micropowder having the opposite charge polarity from that of the toner matrix particles is an effective way to lessen the charge of the toner to be pulverized.

Constant-amount cut out will be unstable if the average particle size is less than 8 nm, but pulverization uniformity will be poor if the average particle size is greater than 40 nm. The micropowder will scatter if the ignition loss is less than 0.5 wt %, but micropowder agglomeration will be severe and the toner to be pulverized will not be supplied uniformly if the ignition loss is greater than 25 wt %. This inorganic micropowder adheres to the toner surface in a state of electrostatic adhesion, without being affixed to the toner matrix. The inorganic micropowder preferably is supplied in an amount of about 0.1 to 5 wt % of the supply amount of the toner to be pulverized.

The gap between the convex part of the rotor and the convex part of the stator is 0.5 to 40 mm, and preferably 0.5 to 10 mm, and even more preferably 0.5 to 6 mm. This improves pulverization efficiency and makes the particles more spherical. There will be a pronounced increase in contact between the particles and the rotor and stator if the gap is smaller than 0.5 mm, so that much more frictional heat will be generated, which causes toner fusion at the above-mentioned distal end. If the gap is larger than 40 mm, it will be impossible to generate a flow with a strong, high-speed stream, making adequate pulverization unattainable.

This method allows pulverization to be performed simultaneously with the external additions, the advantage of which is a shorter manufacturing process. Also, the corners of the toner particles are cleanly rounded off, so that fluidity improves.

If the toner fluidity is low, there will be unevenness in solid image areas, friction chargeability will decrease, the amount of opposite polarity toner will increase, toner will stubbornly adhere to the non-image portions of the photosensitive member and cannot be removed, resulting in base fogging that adversely affects the image, and transfer efficiency will decrease. If the fluidity of the toner is raised by increasing the amount of external added silica, friction charging will be more uniform, there will be less base fogging, image density will increase, and the unevenness in solid black image portions will tend to be eliminated. However, this can create problems such as silica or toner filming on the photosensitive member, or the adhesion of white spots of agglomerated silica to the solid black image portions. Accordingly, the addition of a small amount of silica yields high fluidity, suppresses the occurrence of suspended silica, and suppresses the occurrence of silica and toner filming on the intermediate transfer member and the photosensitive member, and silica white spots in the solid black image portions. This also suppresses the occurrence of the unevenness in solid black image portions that is seen in toners of low fluidity, results in more uniform transfer, and keeps the occurrence of opposite polarity toner infrequent, and therefore increases transfer efficiency.

Furthermore, even when transfer is performed at the required pressing force in places where the toner agglomerates, such as characters and lines, and especially under high temperature and humidity, because of the high fluidity of the toner, the toner particles will not readily agglomerate, and a sharp image without partial transfer defects will be obtained.

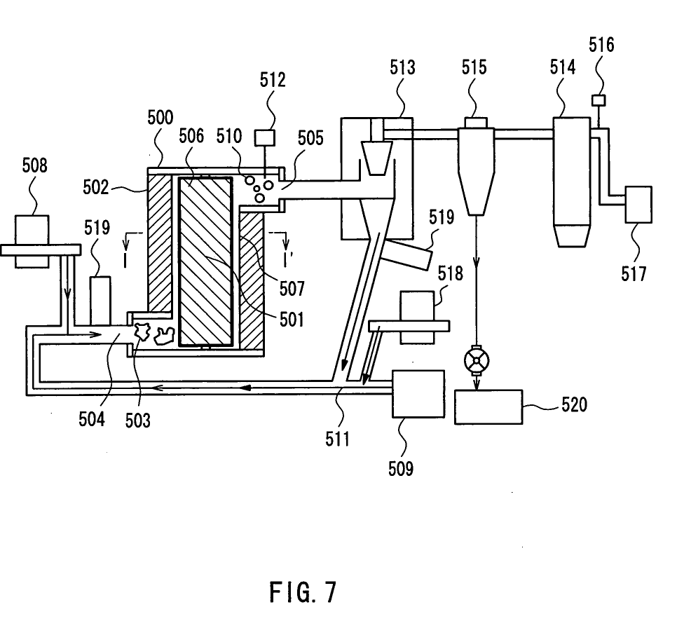

A working example of the toner pulverization apparatus in this embodiment shown in FIG. 7 will now be described. A toner to be pulverized 503, which is the portion of a kneaded material that has been coarsely pulverized and has passed through a mesh with a diameter of approximately 1 to 5 mm, is introduced from a metering supply unit 508 and is sent to a pulverization supply section by cooling air 511 supplied by a cooling unit 509, and this toner is pulverized by a pulverizer 500. Raw material 503 is introduced from an inlet 504, and is carried to the space between a rotor 501, which rotates at high speed and has a jagged component 506 on its surface, and a stator 502, which has a jagged component 507 on its surface and is positioned with a narrow gap between itself and the rotor 501. The raw material particles collide with each other powerfully and are spherically pulverized in the high-speed flow generated between the stator and the rotor that is rotating at high speed. The particles 510 that have been made spherical come out through a discharge outlet 505 and are sent to a coarse powder grader 513, and these coarse particles are once again sent through the inlet 504 by the air 511. The product is sent to a cyclone 515 and recovered in a dust trap 520. 512 is a thermometer, 514 is a bag filter, 516 is an airflow meter, and 517 is a blower. 519 is a vibrator, and 518 is an inorganic micropowder supply apparatus. When the particles are separated in the coarse powder grading and sent back to the pulverizing section, it is preferable for the inorganic micropowder to be supplied from the rear. This allows the inorganic micropowder to be mixed more uniformly during collision with the pulverized powder. An evaporative solvent also can be supplied instead of the inorganic micropowder.

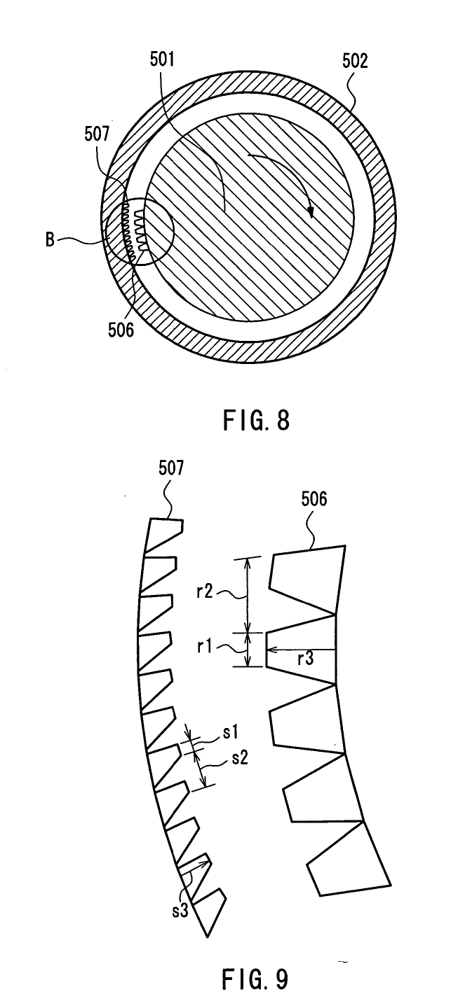

FIG. 8 is a cross section along the I-I line in FIG. 7. FIG. 9 is a detail view of the location B in FIG. 8. s1 is the width of the protrusions of the surface jagged component 507 of the stator 502, s2 is the distance between the protrusions of the surface jagged component 507 of the stator 502, s3 is the height of the protrusions of the surface jagged component 507 of the stator 502, r1 is the width of the protrusions of the surface jagged component 506 of the rotor 501, r2 is the distance between the protrusions of the surface jagged component 506 of the rotor 501, and r3 is the height of the protrusions of the surface jagged component 506 of the rotor 501. The rotor rotates at high speed, and in order for the toner to be pulverized efficiently into a spherical shape of small particle size while silica or another inorganic micropowder is being supplied, the configuration can be such that the density of the surface jagged component 507 of the stator 502 is higher than the density of the jagged component 506 of the rotor 501. It is preferable for the configuration to be such that there is at least one protrusion (and even more preferably, 2.5) per centimeter of peripheral length. It is also preferable if the relationships 0.2≦s1/r1≦0.7 and 0.2≦s2/r2≦0.7 are satisfied. In particular, as the powder is being pulverized while an inorganic micropowder is supplied, since the powder to be pulverized is introduced in a uniformly dispersed state, the density must be raised in order to stabilize the collisions with the wall face of the stator. Below 0.2, costs will be higher in surface processing, but over 0.7, the eddy flow will be uneven and it will be difficult to pulverize the powder to a small particle size.

(10) Polymerization Method

Emulsion polymerization, suspension polymerization, or the like can be used preferably as the method for producing a toner of small particle size.

With emulsion polymerization, a resin microparticle solution containing an ionic surfactant is prepared, this is mixed with a colorant particle dispersion and a wax release agent particle dispersion, and this mixture is agglomerated with an ionic surfactant having the opposite polarity from that of the above-mentioned ionic surfactant, thereby forming toner-based agglomerated particles, after which these are heated to a temperature above the glass transition point of the resin microparticles so as to fuse the agglomerated particles, and this product is washed and dried to produce a toner.

Examples of the surfactant used here include anionic surfactants based on a sulfate, sulfonate, phosphate, or soap, and cationic surfactants such as amine salt types and quaternary ammonium salt types. The concurrent use of a nonionic surfactant, such as one based on polyethylene glycol, an alkylphenol ethylene oxide adduct, or a polyhydric alcohol, is also effective. The means for dispersing these can be a rotary shear type of homogenizer, or a dynomill, sand mill, or ball mill having media, or any other such standard means.

After the particles have been produced, the desired toner can be obtained through a washing step, solid-liquid separation step, and drying step as needed, but in order to achieve and maintain chargeability, the washing step is preferable carried out by sufficient replacement washing with ion exchanged water. There are no particular restrictions on the solid-liquid separation step, but in terms of productivity, it is preferable to use absorption filtration, pressurized filtration, or the like. Nor are there any particular restrictions on the drying step, but in terms of productivity, it is preferable to use freeze drying, flash jet drying, flow drying, vibratory flow drying, or the like.

With suspension polymerization, a polymerizable monomer, wax, a colorant, and various other additives are uniformly dissolved or dispersed, heated, and uniformly dissolved or dispersed with a homogenizer, ultrasonic disperser, or the like to produce a monomer composition, after which this monomer system is dispersed with an ordinary stirrer, homomixer, homogenizer, or the like in an aqueous phase of the same temperature as the monomer system and containing a dispersion stabilizer.

Preferably, the stirring speed and duration are adjusted so that the monomer liquid drops will be the same size as the required size of the toner particles. After this, the particle state is maintained by the action of the dispersion stabilizer, and the system is stirred enough that the particles will not settle. The polymerization temperature is at least 40° C., and is generally set to between 50 and 80° C.

It is preferable here for the stirring speed to be at least 30 m/sec in order to highly disperse the fixing adjuvant and to obtain small toner particles that contain the fixing adjuvant and have a uniform size distribution.

Upon completion of the reaction, the toner particles thus produced are washed, recovered by filtration, and dried. In suspension polymerization, it is usually preferable to use water as a dispersion medium in an amount of 300 to 3000 parts by weight per 100 parts by weight of the monomer system.

All the dispersion media used here can be used by dispersing a suitable stabilizer in an aqueous phase, examples of which include organic compounds such as polyvinyl alcohol, gelatin, methyl cellulose, methyl hydroxypropyl cellulose, ethyl cellulose and carboxymethyl cellulose sodium salt, polyacrylic acid and salts thereof, and starch, and inorganic compounds such as tricalcium phosphate, magnesium phosphate, aluminum phosphate, zinc phosphate, calcium carbonate, magnesium carbonate, barium sulfate, calcium sulfate, aluminum hydroxide, magnesium hydroxide, calcium metasilicate, bentonite, silica, and alumina.

Of these dispersion stabilizers, when an inorganic compound is used, the inorganic compound may be produced in an aqueous medium in order to obtain finer particles. For example, in the case of calcium phosphate, a sodium phosphate aqueous solution may be mixed with a calcium chloride aqueous solution under high speed stirring.

Also, in order to achieve a fine dispersion of these stabilizers, a surfactant may be used in an amount of 0.001 to 0.1 parts by weight. The purpose of this is to promote the desired action of the above-mentioned dispersion stabilizer, and specific examples thereof include sodium dodecylbenzene sulfate, sodium tetradecyl sulfate, sodium pentadecyl sulfate, sodium octyl sulfate, sodium oleate, sodium laurate, potassium stearate, and calcium oleate. Azo and diazo polymerization initiators can be used as well, such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

(11) Two-Component Developing

An AC bias is applied along with a DC bias between the photosensitive member and the developing roller. The frequency here is from 1 to 10 kHz, the AC bias is from 1.0 to 2.5 kV (p-p), and the peripheral speed ratio between the photosensitive member and the developing roller is from 1:1.2 to 1:2. More preferably, the frequency here is from 3.5 to 8 kHz, the AC bias is from 1.2 to 2.0 kV (p-p), and the peripheral speed ratio between the photosensitive member and the developing roller is from 1:1.6 to 1:1.8.

When this developing process configuration and the toner of this embodiment are used, dots can be faithfully reproduced, and the developing gamma characteristic can be made flatter. Both high image quality and oil-less fixing can be achieved. Also, charge-up under low humidity can be prevented even with a high-resistance carrier, allowing high image density to be obtained even in continuous use. The reason for this is believed to be that the combined use of a toner that affords high chargeability, this carrier constitution, and an AC bias allows adhesive strength with the carrier to be reduced, the image density to be maintained, and fogging to be reduced, and also allows dots to be reproduced faithfully. If the frequency is lower than 1 kHz, dot reproducibility will worsen, as will halftone reproducibility. If the frequency is higher than 10 kHz, it will be impossible to keep up in the developing region and no further effect will be realized. In this frequency region, in two-component developing using a high-resistance carrier, the reciprocal action is at work more between the carrier and the toner than between the developing roller and the photosensitive member, having the effect of microscopically isolating the toner from the carrier, and this affords good dot reproducibility and halftone reproducibility, and also results in high image density.

If the AC bias is less than 1.0 kV (p-p), there will be no effect of suppressing charge-up, but fogging will increase if the AC bias is greater than 2.5 kV (p-p). If the peripheral speed ratio between the photosensitive member and the developing roller is less than 1:1.2 (that is, if the developing roller is slowed), it will be difficult to obtain good image density. If the peripheral speed ratio between the photosensitive member and the developing roller is greater than 1:2 (that is, if the developing roller speeds up), there will be more toner scattering.

(12) Tandem Color Process

In order to form a color image at high speed, in this embodiment there are a plurality of toner image forming stations including at least a photosensitive member, charging means, and a toner support, the electrostatic latent image formed on the image support is visualized, a primary transfer process in which the toner image produced by the visualization of the electrostatic latent image is transferred to an endless transfer member by bringing the transfer member into contact with the image support, is sequentially and continuously executed to form a multilayer transferred toner image on the transfer member, and then a secondary transfer process, in which the multilayer toner image formed on the transfer member is transferred all at once to a transfer medium such as paper or an OHP sheet, is executed, and in this transfer process the transfer location is such that d1/v≦0.65 (sec), when d1 (mm) is the distance from a first primary transfer position to a second primary transfer position, and v (mm/s) is the peripheral speed of the photosensitive member. This both makes the machine more compact and affords higher printing speed. In order to be able to process at least 16 sheets (A4) per minute, and to reduce the size of the machine to the point that it can be used in SOHO applications, it is essential that the toner image forming stations be spaced closely together and the process speed raised. A constitution in which the above-mentioned value is 0.65 or less is believed to be the minimum in order to achieve both this compact size and high printing speed.

However, when this constitution is employed, for example, after the first color of toner (yellow) has undergone primary transfer, the time until the second color of toner (magenta) undergoes primary transfer is extremely short, there is virtually no lessening of charge of the transfer member or lessening of charge of the transferred toner, and when the magenta toner is transferred over the yellow toner, the magenta toner is repelled by the charge action of the yellow toner, which decreases the transfer efficiency and causes partial transfer defects in characters. Furthermore, during the primary transfer of the third color of toner (cyan), the cyan toner is scattered in the course of being transferred over the yellow and magenta toner, resulting in pronounced partial transfer defects and other such defects during transfer. As this process is repeated, toner of a specific particle size is selectively developed, there is a considerable difference in the fluidity of individual toner particles, and they will have differing opportunities for friction charging, which creates variance in the amount of charge and leads to inferior transfer performance.

In view of this, adopting the developing constitution of this embodiment results in the uniform dispersion of wax and other internal additives in the resin, and used with a carrier whose surface properties have been improved, this stabilizes the charge distribution, suppresses excess charging of the toner, and suppresses fluidity fluctuations, so that a decrease in transfer efficiency and partial transfer defects of characters during transfer can be prevented without sacrificing fixing characteristics.

(13) Cleaner-Less Process

This embodiment also can be applied preferably to an image formation apparatus whose basic configuration is a cleaner-less process in which the subsequent charging, exposure, and developing processes are performed without first going through a cleaning process in which toner remaining on the photosensitive member after the transfer process is recovered by cleaning.

Using the developer of this embodiment suppresses agglomeration of the toner, prevents excessive charging, yields stable chargeability, and allows high transfer efficiency to be obtained. It also improves uniform dispersibility in the resin, affords good chargeability, and takes advantage of the good partability of the material, allowing any toner remaining on the non-image portions to be recovered well in developing. Accordingly, there is no developing memory, in which the previous image pattern remains in the non-image portions.

(14) Oil-Less Color Fixing

This embodiment also can be used preferably in an image formation apparatus equipped with a fixing process designed for oil-less fixing, in which no oil is used in the means for fixing the toner. Electromagnetic inductive heating is preferable as the heating means here because it requires a shorter warm-up period and consumes less energy. A heating and pressing means is used here that has at least a magnetic field generation means, a rotary heating member comprising at least a parting layer and a heat generating layer that works by electromagnetic induction, and a rotary pressing member that forms a constant nip with said rotary heating member. Transfer paper or another such transfer medium onto which toner has been transferred is passed between the rotary heating member and the rotary pressing member to fix the toner. The distinctive feature here is that the rise time during warm-up to the temperature of the rotary heating member is much shorter than when a conventional halogen lamp is used. Accordingly, the transfer operation begins while the rotary pressing member has yet to be fully heated, so that low temperature fixing and a wide range of offset resistance are required.

A preferable constitution is to use a fixing belt that separates the heating member and fixing member. A heat-resistant belt such as a polyimide belt or a belt electrocast with nickel that is both heat resistant and deformable can be used preferably as this belt. A silicone rubber, fluororubber, or fluororesin can be used to improve partability.

In the fixing of these, up to now offset has been prevented by coating with a parting oil. If a toner that has partability without the use of an oil is used, then there is no need to coat with a parting oil. However, charging tends to occur if there is no coating with a parting oil, and when an unfixed toner image draws near to the heating member or fixing member, the effect of this charging sometimes causes the toner to scatter. This is particularly apt to occur under low temperature and humidity.

By using the toner of this embodiment, however, a low temperature fixing and a wide range of offset resistance can be realized without having to use an oil, and color high optical transmissivity can be obtained. This also suppresses excessive charging of the toner, and suppresses toner scattering caused by the charge effect with the heating member or fixing member.

### WORKING EXAMPLES

The present invention now will be described in further detail through working examples, but the present invention is not limited to or by these examples.

### CARRIER MANUFACTURING EXAMPLE 1

39.7 mol % MnO, 9.9 mol % MgO, 49.6 mol % Fe₂O₃, and 0.8 mol % SrO were pulverized for 10 hours in a wet ball mill, then mixed and dried, after which this mixture was pre-baked by being held at 950° C. for 4 hours. This product was pulverized in the wet ball mill for 24 hours, then granulated with a spray dryer, dried, and baked by being held at 1270° C. for 6 hours in an electric furnace in an atmosphere of 2% oxygen concentration. This product was then cracked and graded, which gave a core material made of ferrite particles whose average size was 50 μm and in which the saturation magnetization was 65 emu/g when a magnetic field of 3000 oersted was applied.

Next, 250 g of a polyorganosiloxane including 15.4 mol % (CH₃)₂SiO units expressed by Chemical Formula 8 below and 84.6 mol % CH₃SiO_{3/2} units expressed by Chemical Formula 9 was reacted with 21 g of CF₃CH₂CH₂Si(OCH₃)₃, which gave a fluorine-modified silicone resin. This was a demethoxylation reaction by which an organosilicon compound molecule containing a perfluoro alkyl group was introduced into the polyorganosiloxane. In addition, 100 g (calculated as solids) of this fluorine-modified silicone resin and 10 g of an aminosilane coupling agent (gamma-aminopropyltriethoxysilane) were weighed out and dissolved in 300 cc of toluene solvent.

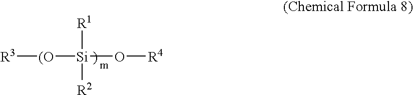

(Where R¹, R², R³, and R⁴ are each a methyl group, and m is 100, representing the average degree of polymerization.)

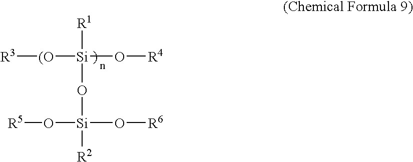

(Where R¹, R², R³, R⁴, R⁵, and R⁶ are each a methyl group, and n is 80, representing the average degree of polymerization.)

10 kg of the above ferrite particles were coated using an immersion dry coating apparatus, after which this product was baked at 260° C. for 1.5 hours to obtain a carrier A1.

### CARRIER MANUFACTURING EXAMPLE 2

A core material was manufactured and coated by the same process as in Carrier Manufacturing Example 1, except that the CF₃CH₂CH₂Si(OCH₃)₃ was changed to C₈F₁₇CH₂CH₂Si(OCH₃)₃, which gave a carrier A2.

### CARRIER MANUFACTURING EXAMPLE 3

A core material was manufactured and coated by the same process as in Carrier Manufacturing Example 1, except that conductive carbon (EC, made by Ketjenblack International) was dispersed at a ratio of 5wt % with respect to the resin solids by using a ball mill, which gave a carrier A3.

### CARRIER MANUFACTURING EXAMPLE 4

A core material was manufactured and coated by the same process as in Carrier Manufacturing Example 3, except that the added amount of aminosilane coupling agent was changed to 30 g, which gave a carrier A4.

### CARRIER MANUFACTURING EXAMPLE 5

A core material was manufactured and coated by the same process as in Carrier Manufacturing Example 3, except that the added amount of aminosilane coupling agent was changed to 50 g, which gave a carrier b1.

### CARRIER MANUFACTURING EXAMPLE 6

A core material was manufactured and coated by the same process as in Carrier Manufacturing Example 1, except that the coating resin was changed to straight silicone (SR-2411, made by Dow Corning Toray Silicone), which gave a carrier b2.

### CARRIER MANUFACTURING EXAMPLE 7

A core material was manufactured and coated by the same process as in Carrier Manufacturing Example 3, except that the coating resin was changed to a copolymer of perfluoro-octylethyl acrylate and methacrylate, which gave a carrier b3.

### CARRIER MANUFACTURING EXAMPLE 8

A core material was manufactured and coated by the same process as in Carrier Manufacturing Example 3, except that the coating resin was changed to an acrylic-modified silicone resin (KR-9706, made by Shin-Etsu Chemical), which gave a carrier b4.

Table 1 shows characteristics of the binder resin used in this working example. The resins were a polyester resin whose main component was a bisphenol A propyl oxide adduct, terephthalic acid, trimellitic acid, succinic acid, or fumaric acid, and whose thermal characteristics were varied by means of the polymerization conditions and the mix proportion. This constitution combining a dihydric alcohol with a dicarboxylic acid or tricarboxylic acid is preferable for achieving good fixability, dispersibility, carrier toner-spent resistance, and pulverization.

TABLE 1

| | Resin | | | | | | |
|---|---|---|---|---|---|---|---|
| | PES-1 | PES-2 | PES-3 | PES-4 | PES-5 | PES-6 | pes-7 |
| Mnf (×10⁴) | 0.32 | 0.52 | 0.57 | 0.59 | 0.32 | 0.32 | 0.23 |
| Mwf (×10⁴) | 2.10 | 4.40 | 5.60 | 5.91 | 6.40 | 10.20 | 1.40 |
| Mzf (×10⁴) | 26.50 | 31.00 | 31.50 | 40.50 | 97.50 | 302.50 | 7.40 |
| Wmf = Mwf/Mnf | 6.56 | 8.46 | 9.82 | 10.02 | 20.00 | 31.88 | 6.09 |
| Wzf = Mzf/Mnf | 82.81 | 59.62 | 55.26 | 68.64 | 304.69 | 945.31 | 32.17 |
| Mpf (×10⁴) | 0.62 | 0.74 | 0.88 | 1.02 | 1.8 | 2.2 | 0.5 |
| Tg (° C.) | 57.3 | 57.3 | 55.0 | 55.5 | 58.0 | 61.0 | 54.0 |
| Tm (° C.) | 107.5 | 110.8 | 113.0 | 116.0 | 121.0 | 125.0 | 100.0 |
| Tfb (° C.) | 96.2 | 97.5 | 98.5 | 99.2 | 105.6 | 107.8 | 85.0 |
| AV (mgKOH/g) | 18 | 15 | 28 | 25 | 15 | 20 | 2 |

Mnf is the number average molecular weight of the binder resin, Mwf is the weight average molecular weight of the binder resin, Mzf is the Z average molecular weight of the binder resin, Wmf is the ratio Mwf/Mnf between the weight average molecular weight Mwf and the number average molecular weight Wnf, Wzf is the ratio Mzf/Mnf between the Z average molecular weight Mzf and the number average molecular weight Mnf of the binder resin, Mpf is the peak molecular weight, Tg (° C.) is the glass transition point, Tm (° C.) is the softening point, Tfb (° C.) is the flow beginning temperature, and AV (mgKOH/g) is the resin acid value.

Tables 2, 3, and 4 below list the waxes used in this working example, and the properties thereof. Tw (° C.) is the melting point as measured by DSC, Ct (%) is the volumetric increase (%) at the melting point+10° C., Ck (wt %) is the heating loss at 220° C., Mnr is the number average molecular weight of the wax, Mwr is the weight average molecular weight of the wax, Mzr is the Z average molecular weight of the wax, and “peak” is the peak value of the molecular weight.

TABLE 2

| | | Melting | | Heating | | |
|---|---|---|---|---|---|---|
| | | point | Volumetric | loss | | |
| | | Tw | increase | Ck | Iodine | Saponification |
| Wax | Material | (° C.) | Ct (%) | (wt %) | value | value |
| WA-1 | extremely hydrogenated | 68 | 18.5 | 2.8 | 2 | 95.7 |
| | jojoba oil | | | | | |
| WA-2 | carnauba wax | 83 | 15.3 | 4.1 | 10 | 80 |
| WA-3 | extremely hydrogenated | 71 | 3 | 2.5 | 2 | 90 |
| | meadowfoam oil | | | | | |
| WA-4 | jojoba oil fatty acid | 120 | 3.5 | 3.4 | 2 | 120 |
| | pentaerythritol monoester | | | | | |
| WA-5 | oleic acid amide | 78 | | 0.8 | | |
| WA-6 | ethylene-bis-erucic acid | 105 | | 1.2 | | |
| | amide | | | | | |
| WA-7 | neopentyl polyol fatty acid | 110 | | 2.2 | 0.2 | 150 |
| | ester | | | | | |
| WA-8 | pentaerythritol | 125 | | 0.9 | 0.1 | 180 |
| | tetrastearate | | | | | |

TABLE 3

| | | Melting | | |
|---|---|---|---|---|
| | | point | | |
| | | Tw | Acid | |
| | | (° C.) | value | Penetration |
| WA-9 | ethylene/maleic anhydride/C₃₀ | 98 | 45 | 1 |
| | terminal alcohol-type wax/ | | | |
| | tert-butyl peroxyisopropyl | | | |
| | monocarbonate: 100/20/8/4 | | | |
| | parts by weight | | | |
| WA-10 | propylene/maleic | 120 | 58 | 1 |
| | anhydride/1-octanol/dicumyl | | | |
| | peroxide: 100/15/8/4 parts | | | |
| | by weight | | | |

TABLE 4

| | Mnr | Mwr | Mzr | Mwr/Mnr | Mzr/Mnr | Peak |
|---|---|---|---|---|---|---|
| WA-1 | 1009 | 1072 | 1118 | 1.06 | 1.11 | 1.02 × 10³ |
| WA-2 | 1100 | 1198 | 1290 | 1.09 | 1.17 | 1.2 × 10³ |
| WA-3 | 1015 | 1078 | 1124 | 1.06 | 1.11 | 1.03 × 10³ |
| WA-4 | 1500 | 2048 | 3005 | 1.37 | 2.00 | 3.2 × 10³ |
| WA-5 | 1000 | 1050 | 1200 | 1.05 | 1.20 | 1.8 × 10³ |
| WA-6 | 1002 | 1100 | 1350 | 1.10 | 1.35 | 1.9 × 10³ |
| WA-7 | 1050 | 1205 | 1400 | 1.15 | 1.33 | 2.1 × 10³ |
| WA-8 | 1100 | 1980 | 3050 | 1.80 | 2.77 | 3.5 × 10³ |
| WA-9 | 1400 | 2030 | 2810 | 1.45 | 2.01 | 2.1 × 10³ |
| WA-10 | 1400 | 3250 | 5200 | 2.32 | 3.71 | 3.1 × 10³ |

The melting points of WA-3 and WA-9 are 72.1° C. and 98.5° C.

Table 5 lists the pigments used in this working example.

TABLE 5

| Material No. | Composition |
|---|---|
| CM | magenta pigment:Pigment Red 57:1 |
| CC | cyan pigment:Pigment Blue 15:3 |
| CY | yellow pigment:Pigment Yellow 180 |
| BK | Carbon Black MA 100S (made by Mitsubishi |
| | Chemical) |

Table 6 lists the charge control agents used in this working example, and their properties.

TABLE 6

| Material | | |
|---|---|---|
| No. | Composition | Material |
| CA1 | Cr metal salt of salicylic acid | E-81 (made by Orient Chemical) |
| | derivative | |
| CA2 | K metal salt of benzylic acid | LR-147 (made by Japan Carlit) |
| | derivative | |

In the metal salt of a salicylic acid derivative, examples of C₁ to C₁₀ alkyl groups include a methyl group, ethyl group, n-propyl group, isopropyl group, n-butyl group, isobutyl group, sec-butyl group, and tert-butyl group. Examples of the metal Y include zinc, nickel, cobalt, copper, and chromium, with zinc and chromium being preferred. In the metal salt of a benzylic acid derivative, R¹ to R⁴ can be a benzene ring, and examples of the alkali metal X include lithium, sodium, and potassium, with potassium being preferred.

Table 7 lists the additives used in this working example.

TABLE 7

| | | Particle | Methanol | Moisture | Ignition | Drying | | | 5 min. |
|---|---|---|---|---|---|---|---|---|---|
| Inorganic | | size | titration | adsorption | loss | loss | 5 min. | 30 min. | value/30 min. |
| micropowder | Material | (nm) | (%) | amount | (wt %) | (wt %) | value | value | value |
| S1 | silica treated with dimethyl | 6 | 88 | 0.1 | 24 | 0.2 | −890 | −740 | 83.15 |
| | silicone oil | | | | | | | | |
| S2 | silica treated with dimethyl | 12 | 88 | 0.1 | 18.5 | 0.2 | −670 | −475 | 70.90 |
| | silicone oil | | | | | | | | |
| S3 | silica treated with aluminum | 12 | 78 | 0.09 | 10.5 | 0.2 | −150 | −70 | 46.67 |
| | stearate | | | | | | | | |
| S4 | silica treated with dimethyl | 16 | 88 | 0.12 | 9.5 | 0.2 | −685 | −511 | 74.60 |
| | silicone oil/aluminum stearate | | | | | | | | |
| S5 | silica treated with dimethyl | 40 | 89 | 0.10 | 6.8 | 0.2 | −710 | −580 | 81.69 |
| | silicone oil | | | | | | | | |
| S6 | titanium oxide treated with | 40 | 88 | 0.05 | 5.1 | 0.2 | −860 | −710 | 82.56 |
| | trimethylmethoxysilane/zinc | | | | | | | | |
| | stearate | | | | | | | | |
| S7 | silica treated with dimethyl | 120 | 89 | 0.10 | 8.9 | 0.2 | −370 | −175 | 47.30 |
| | silicone oil | | | | | | | | |
| S8 | silica treated with | 6 | 88 | 0.20 | 6.8 | 0.9 | 740 | 380 | 51.35 |
| | amino-modified silicone oil | | | | | | | | |
| S9 | silica treated with | 12 | 68 | 0.20 | 3.5 | 0.9 | 350 | 120 | 34.29 |
| | amino-modified silicone oil | | | | | | | | |
| S10 | silica treated with | 40 | 73 | 0.10 | 12.5 | 0.2 | 280 | 150 | 53.57 |
| | amino-modified silicone oil | | | | | | | | |
| S11 | silica treated with | 120 | 73 | 0.10 | 838 | 0.2 | 410 | 320 | 78.05 |
| | amino-modified silicone oil | | | | | | | | |
| S12 | silica treated with | 40 | 68 | 0.60 | 1.6 | 0.2 | −800 | −620 | 77.50 |
| | hexamethyldisilazane | | | | | | | | |

The charge amounts of the additives shown in Table 7 were measured by a friction charging blow-off method with a non-coated ferrite carrier. 50 g of carrier and 0.1 g of silica or the like were mixed in a 100 mL polyethylene vessel under an atmosphere 25° C. and 45% RH, the contents were stirred for 5 and 30 minutes by vertical rotation at a speed of 100 min⁻¹, after which 0.3 g was sampled and blown for 1 minute with nitrogen gas at 1.96×10⁴ Pa.

With positive chargeability, it is preferable for the 5 minute value (after 5 minutes of stirring) to be from +100 to +800 μC/g, and for the 30 minute value (after 30 minutes of stirring) to be from +50 to +400 μC/g. It is preferable to use silica that maintains the amount of charge at the 30 minute value at a level of at least 40% of the amount of charge at the 5 minute value. If the proportional decrease is large, there will be considerable change in the amount of charge during long-term continuous use, and a consistent image cannot be maintained.

With negative chargeability, it is preferable for the 5 minute value to be from −100 to −800 μC/g, and for the 30 minute value to be from −50 to −600 μC/g. Silica having a high charge amount can exhibit its function with just a small added amount.

The kneading conditions in this working example are shown in Table 8.

Trj1 (° C.) is the heating temperature at the front half of the roll (RL1), Trk1 (° C.) is the heating temperature at the rear half of the roll (RL1), Tr2 (° C.) is the heating or cooling temperature and both the front and rear of the roll (RL2), Rw1 is the rotational speed of the roll (RL1), Rw2 is the rotational speed of the roll (RL2), Dr1 is the load current value during rotation of the roll (RL1), and Dr2 is the load current value during rotation of the roll (RL2). The amount of raw material introduced was 15 kg/h, the diameter of the rolls RL1 and RL2 was 140 mm, and their length was 800 mm.

TABLE 8

| Kneading | Trj1 | Trk1 | Tr2 | | Rw2 | | Dr1 | Dr2 | |
|---|---|---|---|---|---|---|---|---|---|
| conditions | (° C.) | (° C.) | (° C.) | Rw1 (min⁻¹) | (min⁻¹) | Rw1/Rw2 | (A) | (A) | Dr1/Dr2 |
| Q-1 | 131 | 61 | 20 | 95.0 | 80.0 | 1.2 | 29.2 | 12.1 | 2.4 |
| Q-2 | 152 | 40 | 6 | 95.0 | 65.0 | 1.5 | 31.0 | 16.5 | 1.9 |
| Q-3 | 118 | 55 | 20 | 75.0 | 65.0 | 1.2 | 25.2 | 12.5 | 2.0 |
| q-4 | 100 | 100 | 20 | 60.0 | 60.0 | 1.0 | 19.0 | 19.0 | 1.0 |

Tables 9 and 10 list the pulverization conditions in this working example.

TABLE 9

| | | | Supply | | |
|---|---|---|---|---|---|
| | Gap between | Rotor | amount of | | Discharge |
| | rotor and | peripheral | toner to be | Cooling air | section |
| | stator | speed | pulverized | temperature | temp. |
| KM1 | 1.5 mm | 130 m/s | 5 kg/h | 0° C. | 45° C. |
| KM2 | 1 mm | 120 m/s | 5 kg/h | 0° C. | 40° C. |

TABLE 10

| | | Supply amount of | | |
|---|---|---|---|---|
| | Supplied inorganic | toner to be | Imparting | Imparting |
| | micropowder | pulverized | means 1 | means 2 |
| KS1 | S1 | 0.48 kg/h | | |
| KS2 | S2 | 0.12 kg/h | | |
| KS3 | S4 | 0.09 kg/h | | |
| KS4 | S6 | 0.02 kg/h | vibrator | |
| KS5 | S8 | 0.09 kg/h | vibrator | |
| KS6 | S10 | 0.02 kg/h | | |
| KS7 | | | vibrator | |
| KS8 | | | | ethanol |
| | | | | spraying |

### PULVERIZATION CONDITIONS IN THIS WORKING EXAMPLE

(1) Rotor peripheral speed: 130 m/s, gap between rotor and stator: 1.5 mm, supplied amount of toner to be pulverized: 5 kg/h, supplied amount of inorganic micropowder: 0.03 kg/h, cooling air temperature: 0° C., discharge section temperature: 45° C.

(2) Rotor peripheral speed: 120 m/s, gap between rotor and stator: 1 mm, supplied amount of toner to be pulverized: 5 kg/h, supplied amount of inorganic micropowder: 0.02 kg/h, cooling air temperature: 0° C., discharge section temperature: 40° C. s1 was 1 mm, s2 was 4 mm, s3 was 3 mm, r1 was 4 mm, r2 was 7 mm, r3 was 3 mm, and the circumference of the stator was 57 cm. The inorganic micropowder was subjected to vibration with a vibrator or to spraying with a solvent before being pulverized.

Table 11 shows the composition and properties of the toners used in this working example.

TABLE 11

| | | | | | | External | External | External | Pulverization | Pulverization | Kneading |
|---|---|---|---|---|---|---|---|---|---|---|---|
| Toner | Resin | Charge control agent | Pigment | Wax 1 | Wax 2 | additive A | additive B | additive B | conditions 1 | conditions 2 | conditions |
| TM1 | PES-1 | CA1 (3) | CM (5) | WA1 (8) | | S2 (3.2) | | | KM1 | KS1 | Q-1 |
| TM2 | PES-2 | CA2 (2.5) | CM (5) | WA2 (6) | | S1 (2.2) | S5 (2.5) | | KM2 | KS2 | Q-2 |
| TM3 | PES-3 | CA1 (2) + CA3 (1.5) | CM (5) | WA3 (7) | | S4 (2.0) | S7 (2.8) | | KM1 | KS3 | Q-3 |
| TM4 | PES-4 | CA2 (3) + CA4 (2) | CM (5) | WA4 (8) | | S2 (3.0) | S9 (1.0) | | KM2 | KS6 | Q-1 |
| TM5 | PES-5 | CA1 (1.5) + CA3 (2) | CM (5) | WA1 (5) | WA5 (3) | S1 (1.8) | S5 (1.2) | S8 (0.5) | KM1 | KS7 | Q-2 |
| TM6 | PES-6 | CA2 (3) + CA4 (2) | CM (5) | WA2 (6) | WA6 (2) | S2 (1.5) | S6 (1.2) | S11 (1.5) | KM2 | KS8 | Q-3 |
| tm7 | pes-7 | CA4 (1) | CM (5) | | | S12 (0.3) | | | KM1 | | q-4 |
| TY1 | PES-1 | CA1 (3) | CY (5) | WA9 (8) | | S3 (2.5) | | | KM1 | KS1 | Q-1 |
| TY2 | PES-2 | CA2 (2.5) | CY (5) | WA10 | | S1 (1.5) | S7 (2.8) | | KM2 | KS3 | Q-2 |
| | | | | (6) | | | | | | | |
| TY3 | PES-3 | CA2 (2) + CA3 (1.4) | CY (5) | WA1 (7) | | S4 (2.0) | S7 (2.8) | | KM1 | KS4 | Q-3 |
| TY4 | PES-4 | CA2 (3) + CA4 (2) | CY (5) | WA5 (8) | | S2 (0.5) | S9 (1.5) | | KM2 | KS5 | Q-1 |
| TY5 | PES-5 | CA1 (1.5) + CA3 (2) | CY (5) | WA2 (5) | WA7 (3) | S2 (2.0) | S5 (2.0) | S9 (1.5) | KM1 | KS7 | Q-2 |
| TY6 | PES-6 | CA2 (3) + CA4 (2) | CY (5) | WA3 (6) | WA8 (2) | S2 (2.0) | S7 (2.0) | S11 (1.5) | KM2 | KS8 | Q-3 |
| ty7 | pes-7 | CA4 (1) | CY (5) | | | S12 (0.3) | | | KM1 | | q-4 |
| TC1 | PES-1 | CA1 (3) | CC (5) | WA9 (8) | | S2 (2.5) | | | KM1 | KS1 | Q-1 |
| TC2 | PES-2 | CA2 (2.5) | CC (5) | WA10 | | S1 (1.0) | S7 (2.8) | | KM2 | KS2 | Q-2 |
| | | | | (6) | | | | | | | |
| TC3 | PES-3 | CA1 (2) + CA3 (1.5) | CC (5) | WA2 (7) | | S2 (1.0) | S5 (2.8) | | KM1 | KS3 | Q-3 |
| TC4 | PES-4 | CA2 (3) + CA4 (2) | CC (5) | WA7 (8) | | S2 (3.0) | S9 (1.0) | | KM2 | KS4 | Q-1 |
| TC5 | PES-5 | CA1 (1.5) + CA3 (2) | CC (5) | WA3 (5) | WA4 (3) | S4 (2.0) | S5 (1.2) | S9 (1.5) | KM1 | KS5 | Q-2 |
| TC6 | PES-6 | CA2 (3) + CA4 (2) | CC (5) | WA1 (6) | WA5 (2) | S4 (2) | S7 (2.0) | S10 (1.5) | KM2 | KS6 | Q-3 |
| tc7 | pes-7 | CA4 (1) | CC (5) | | | S12 (0.3) | | | KM1 | | q-4 |
| TB1 | PES-1 | CA1 (3) | BK (5) | WA1 (8) | | S4 (5.3) | | | KM1 | KS1 | Q-1 |
| TB2 | PES-2 | CA2 (2.5) | BK (5) | WA2 (6) | | S2 (2.5) | S7 (2.8) | | KM2 | KS2 | Q-2 |
| TB3 | PES-3 | CA1 (2) + CA3 (1) | BK (5) | WA3 (7) | | S3 (2.5) | S6 (1.5) | | KM1 | KS4 | Q-3 |
| TB4 | PES-4 | CA2 (3) + CA4 (2) | BK (5) | WA8 (8) | | S2 (1.8) | S8 (0.5) | | KM2 | KS5 | Q-1 |
| TB5 | PES-5 | CA1 (1.5) + CA3 (2) | BK (5) | WA9 (5) | WA6 (3) | S3 (2.0) | S6 (2.0) | S8 (0.5) | KM1 | KS6 | Q-2 |
| TB6 | PES-6 | CA2 (3) + CA4 (2) | BK (5) | WA10 | WA7 (2) | S2 (1.5) | S6 (1.2) | S11 (1.5) | KM2 | KS7 | Q-3 |
| | | | | (6) | | | | | | | |
| tb7 | pes-7 | CA4 (1) | BK (5) | | | S12 (0.3) | | | KM1 | | q-4 |

The blend ratios (in parts by weight) for the pigment, the charge control agent, and the wax per 100 parts by weight binder resin are given in parentheses in Table 11. The blend amounts (in parts by weight) for the additives are indicated per 100 parts by weight toner matrix. The external addition was performed with an FM20B, using a model ZOSO agitator blade at a rotational speed of 2000 min⁻¹, for a treatment time of 5 minutes, and at an added amount of 1 kg.

Tables 12 and 13 show the molecular weight characteristics of toners that have been subjected to the kneading treatment of this working example. The toners were comparatively evaluated using magenta toners TM1 to TM7. Similar results are obtained with yellow, cyan, and black toners. Mnv is the number average molecular weight of a toner, Mwv is the weight average molecular weight of a toner, Wmv is the ratio Mwv/Mnv of the weight average molecular weight Mwv to the number average molecular weight Mnv of a toner, and Wzv is the ratio Mzv/Mnv of the Z average molecular weight Mzv to the number average molecular weight Mnv.

ML is the molecular weight at which the molecular weight maximum peak appears on the low molecular weight side in the molecular weight distribution, MH is the molecular weight at which the molecular weight maximum peak appears on the high molecular weight side, Sm is Hb/Ha, SK1 is M10/M90, and SK2 is (M10−M90)/M90.

TABLE 12

| | Toner | | | | | | |
|---|---|---|---|---|---|---|---|
| | TM-1 | TM-2 | TM-3 | TM-4 | TM-5 | TM-6 | tm-7 |
| Mnv (×10⁴) | 0.33 | 0.50 | 0.51 | 0.64 | 0.36 | 0.31 | 0.24 |
| Mwv (×10⁴) | 1.82 | 2.98 | 3.62 | 3.89 | 3.25 | 4.68 | 1.20 |
| Mzv (×10⁴) | 7.98 | 9.86 | 12.88 | 13.12 | 15.21 | 84.60 | 4.90 |
| Wmv = Mwv/ | 5.52 | 5.96 | 7.10 | 6.08 | 9.03 | 15.10 | 5.00 |
| Mnv | | | | | | | |
| Wzv = Mzv/Mnv | 24.18 | 19.72 | 25.25 | 20.50 | 42.26 | 272.90 | 20.42 |

TABLE 13

| | Toner | | | | | | |
|---|---|---|---|---|---|---|---|
| | TM-1 | TM-2 | TM-3 | TM-4 | TM-5 | TM-6 | tm-7 |
| ML (×10⁴) | 0.55 | 0.84 | 0.86 | 1.08 | 0.81 | 0.79 | 0.46 |
| MH (×10⁴) | 10.90 | 9.38 | 10.00 | 9.20 | 13.30 | 18.20 | |
| Sm | 0.20 | 0.48 | 0.51 | 0.73 | 0.40 | 0.37 | |
| SK1 | 2.2 | 2.04 | 2.88 | 1.58 | 2.25 | 1.81 | |
| SK2 | 1.21 | 1.04 | 1.89 | 0.58 | 1.25 | 0.81 | |

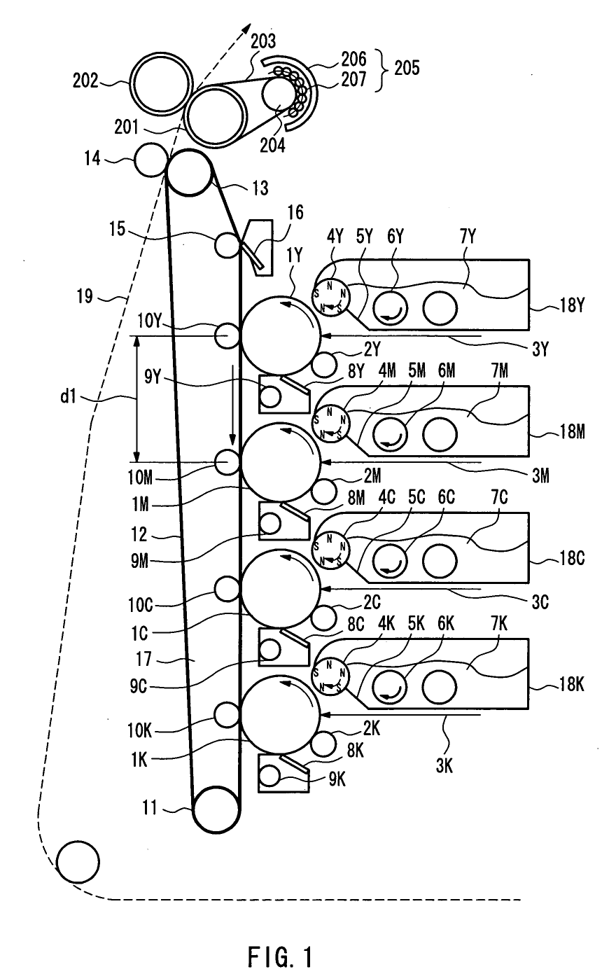

FIG. 1 is a cross section of the structure of an image formation apparatus for full-color image formation used in this working example. FIG. 1 shows a color electrophotographic printer, with its outer housing removed. A transfer belt unit 17 comprises a transfer belt 12, a first color (yellow) transfer roller 10Y, a second color (magenta) transfer roller 10M, a third color (cyan) transfer roller 10C., a fourth color (black) transfer roller 10K (these rollers are all made from elastic materials), a drive roller 11 made from aluminum, a second transfer roller 14 made from an elastic material, a second transfer driven roller 13, a belt cleaner blade 16 for cleaning away toner remaining on the transfer belt 12, and a roller 15 located across from the cleaner blade. The distance d1 from the first color (Y) transfer position to the second color (M) transfer position is 70 mm (this is the same distance from the second color (M) transfer position to the third color (C) transfer position, and from the third color (C) transfer position to the fourth color (K) transfer position), and the peripheral speed of the photosensitive member is 125 mm/s.

The transfer belt 12 is produced by kneading a conductive filler into an insulating polycarbonate resin, and extruding this mixture in the form of a film. In this working example, the insulating resin was produced by adding 5 parts by weight conductive carbon (such as ketjen black) to 95 parts by weight polycarbonate resin (such as Iupilon Z300, made by Mitsubishi Gas Chemical) and then forming a film from this mixture. The surface was coated with a fluororesin, the thickness of the film was approximately 100 μm, the volumetric resistance was from 10⁷ to 10¹² Ω·cm, and the surface resistance was from 10⁷ to 10¹² ohms per square. The purpose of this was to enhance dot reproducibility, and to effectively prevent the accumulation of charge and slackness in the transfer belt 12 over extended use. The reason for coating the surface with a fluororesin was to prevent effectively toner filming on the surface of the transfer belt over extended use. Retransfer will tend to occur if the volumetric resistance is less than 10⁷ Ω·cm, but transfer efficiency will drop if volumetric resistance is greater than 10¹² Ω·C The first transfer roller is a carbon conductive foamed urethane roller with an outside diameter of 10 mm and a resistance of 10² to 10⁶ Ω. During the first transfer operation, the first transfer roller 10 is pressed against a photosensitive member 1 via the transfer belt 12 at a pressing force of 1.0 to 9.8 N, and the toner on the photosensitive member is transferred onto the belt. Retransfer will tend to occur if the resistance is less than 10² Ω, but transfer defects will tend to occur if 10⁶ Ω is exceeded. Transfer defects also will occur if the pressing force is under 1.0 N, but partial transfer defects will occur over 9.8 N.

The second transfer roller 14 is a carbon conductive foamed urethane roller with an outside diameter of 15 mm and a resistance of 10² to 10⁶ Ω. The second transfer roller 14 is pressed against the transfer roller 13 via the transfer belt 12 and a transfer medium 19, such as paper or an OHP sheet. This transfer roller 13 is designed to be rotationally driven by the transfer belt 12. In the second transfer, the second transfer roller 14 and the opposing transfer roller 13 are pressed together at a pressing force of 5.0 to 21.8 N, and the toner is transferred from the transfer belt onto the paper or other recording material 19 such as paper. Retransfer will tend to occur if the resistance is less than 10² Ω, but transfer defects will tend to occur if 10⁶ Ω is exceeded. Transfer defects will also occur if the pressing force is under 5.0 N, but the load will be too high and jitter will tend to occur over 21.8 N.

Four image formation units 18Y, 18M, 18C, and 18K for the various colors (yellow (Y), magenta (M), cyan (C), and black (B)) are disposed in a row as shown in the drawing.

Aside from the developers contained therein, the image formation units 18Y, 18M, 18C, and 18K all have the same constituent members, so that for the sake of simplicity, only the image formation unit 18Y used for yellow will be described, and not the other units.

The image formation unit is constituted as follows. 1 is a photosensitive member, 3 is a pixel laser signal light, and 4 is a developing roller that is made of aluminum, has an outside diameter of 12 mm, and has a magnet with a magnetic force of 1200 gauss. This developing roller is located across from the photosensitive member at a gap of 0.3 mm, and rotates in the direction indicated by the arrow. 6 is an agitation roller, which agitates the carrier and the toner inside the developing unit and supplies them to the developing roller. The carrier and toner blend ratio is read by magnetic permeability sensor (not shown), and material is supplied as needed from a toner hopper (not shown). 5 is a magnetic blade made of metal, which restricts the magnetic brush layer of the developer on the developing roller. The amount of developer introduced is 150 g. The gap was set at 0.4 mm. Although not depicted, the power supply applied to the developing roller 4 was −500V DC current and 1.5V (p-p) AC current with a frequency of 6 kHz. The peripheral speed ratio between the photosensitive member and the developing roller was set at 1:1.6. The toner and carrier were mixed in a ratio of 93:7, and the amount of developer in the developing unit was 150 g. 2 is a charging roller made of epichlorohydrin rubber and having an outside diameter of 12 mm, to which is applied a DC bias of −1.2 kV. This roller charges the surface of the photosensitive member 1 to −600V. 8 is a cleaner, 9 is a waste toner box, and 7 is developer. The paper conveyance path is formed so that paper 19 is conveyed from beneath the transfer unit 17, and the paper is sent by a paper conveyance roller (not shown) into a nip where the transfer belt 12 and the second transfer roller 14 are pressed together. The toner on the transfer belt 12 is transferred on the copy paper 19 by the +1000V voltage applied to the second transfer roller 14, and is fixed after being conveyed to a fixing section made up of a fixing roller 201, a press roller 202, a fixing belt 203, a heating medium roller 204, and an induction heater 205.

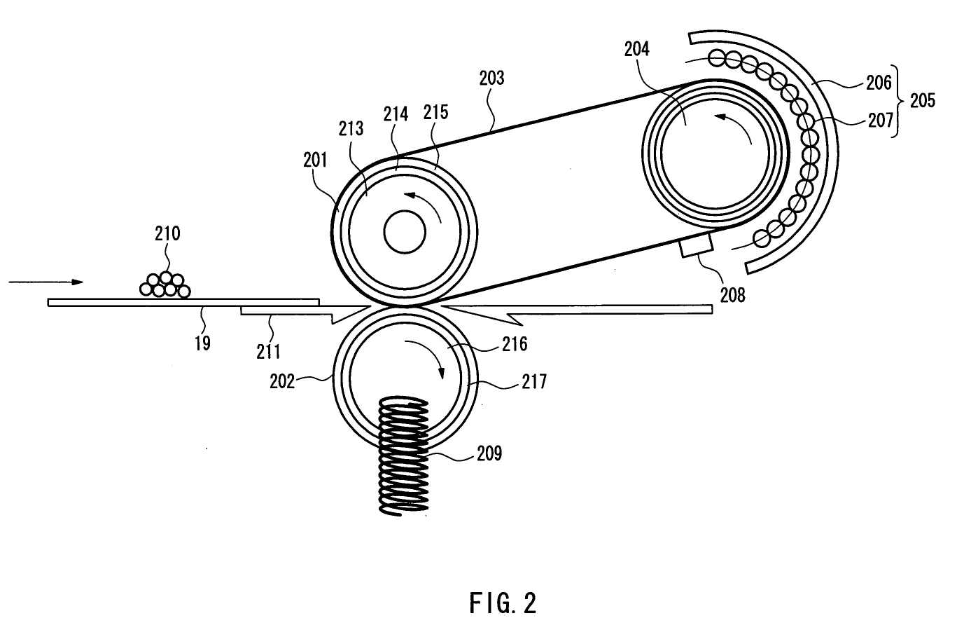

FIG. 2 illustrates this fixing process. The belt 203 adheres around the fixing roller 201 and the heat roller 204. A specific weight is applied between the fixing roller 201 and the press roller 202, forming a nip between the belt 203 and the press roller 202. The induction heater 205, which comprises a ferrite core 206 and a coil 207, is provided on the outer peripheral surface of the heat roller 204, and a temperature sensor 208 is disposed on the outside. The belt has a 30 μm nickel belt, over which is provided a silicone rubber layer of 150 μm, and over this a PFA tube of 30 μm. The press roller 202 is pressed against the fixing roller 201 by a pressing spring 209. The recording material 19 having a toner 210 moves along a guide plate 211. The fixing roller 201 (which serves as the fixing member) comprises an elastic layer 214 having a thickness of 3 mm and composed of silicone rubber with a rubber hardness (according to JIS-A) of 20, provided over the surface of a hollow aluminum roller core 213 with a length of 250 mm, an outside diameter of 14 mm, and a thickness of 1 mm. A silicone rubber layer 215 is formed over this in a thickness of 3 mm, giving an outside diameter of approximately 20 mm. The roller is rotated at 125 mm/s by drive force from a drive motor (not shown). The heat roller 204 includes a hollow pipe with an outside diameter of 20 mm and a wall thickness of 1 mm. The fixing belt surface temperature was held at 170° C. with a thermistor. The press roller 202 serving as the pressing member has a length of 250 mm and an outside diameter of 20 mm. This roller comprises an elastic layer 217 having a thickness of 2 mm and composed of silicone rubber with a rubber hardness (according to JIS-A) of 55, provided over the surface of a hollow aluminum roller core 216 with a length of 250 mm, an outside diameter of 16 mm, and a thickness of 1 mm. This press roller 202 is rotatably disposed, and forms a nip width of 5.0 mm with the fixing roller 201 when biased by a spring 209 with a spring weight on one side of 147 N.

The operation now will be described. In full-color mode, the first transfer rollers 10Y, 10M, 10C., and 10K are all pushed up so as to press against the photosensitive member 1 of the image formation units via the transfer belt 12. At this point a DC bias of +800V is applied to the first transfer rollers. Image signals are sent by laser beams 3 and are incident on the photosensitive members 1 whose surfaces have been charged by the charging rollers 2, forming electrostatic latent images. The toner on the developing rollers 4 that rotate in contact with the photosensitive members 1 makes visible the electrostatic latent images formed on the photosensitive members 1.

The speed of image formation of the image formation unit 18Y (125 mm/s, which is equal to the peripheral speed of the photosensitive member), and the moving speed of the transfer belt 12 are set to be from 0.5 to 1.5% slower than the photosensitive member speed.

The result of the image formation step is that yellow signal light 3Y is inputted to the image formation unit 18Y, and an image is formed by yellow toner. Simultaneously with this image formation, the yellow toner image is transferred from the photosensitive member 1Y to the transfer belt 12 by the action of the first transfer roller 10Y. A DC voltage of +800V was applied to the first transfer roller 10Y at this point. Magenta signal light 3M is inputted to the image formation unit 18M at a specific timing between the first color (yellow) first transfer and second color (magenta) first transfer, an image is formed by magenta toner, and simultaneously with this image formation, the magenta toner image is transferred from the photosensitive member 1M to the transfer belt 12 by the action of the first transfer roller 10M. At this point the magenta toner is transferred over the first color (yellow) toner. Similarly, images are formed from cyan and black toner, and simultaneously with this image formation, a YMCK toner image is formed on the transfer belt 12 by the action of the first transfer rollers 10C and 10B. This is known as a tandem method. A color image is formed by positionally aligning and superimposing four colors of toner image on the transfer belt 12. After the transfer of the last toner image (black), the four-color toner image is transferred all at once by the action of the second transfer roller 14 onto the paper 19 sent from a paper feed cassette (not shown) at a specific timing. The transfer roller 13 is grounded at this point, and a DC voltage of +1 kV is applied to the second transfer roller 14. The toner image transferred to the paper is fixed by the pair of fixing rollers 201 and 202. The paper then goes through a discharge roller pair (not shown) and is discharged to the outside of the apparatus. Any toner remaining untransferred on the intermediate transfer belt 12 is removed by the action of the cleaner blade 16, so that the belt will be ready for the next image formation. Table 14 shows the results of imaging performed by the electrophotographic apparatus shown in FIG. 1. Table 15 gives evaluations of the state of transfer defects in the character portion of a full-color image consisting of three overlapping colors, and of how much the paper adheres to the fixing belt during fixing. The charge amount was measured by a friction charging blow-off method with a ferrite carrier. 0.3 g was sampled for durability evaluation, and was blown for 1 minute with nitrogen gas at 1.96×10⁴ Pa at 25° C. and 45% RH.

TABLE 14

| | | | | Image density | | | | |
|---|---|---|---|---|---|---|---|---|
| | | | Photosensitive | (ID) | | | Skipped | |
| | | | member | initial/after | | Overall solid | characters during | Toner disruption |
| Developer | Toner | Carrier | filming | test | Fogging | image uniformity | transfer | during fixing |
| DM1 | TM1 | A1 | no | 1.41/1.41 | pass | pass | no | none |
| DM2 | TM2 | A2 | no | 1.44/1.52 | pass | pass | no | none |
| DM3 | TM3 | A3 | no | 1.42/1.46 | pass | pass | no | none |
| DM4 | TM4 | A4 | no | 1.41/1.44 | pass | pass | no | none |
| DM5 | TM5 | A1 | no | 1.41/1.46 | pass | pass | no | none |
| DM6 | TM6 | A2 | no | 1.42/1.45 | pass | pass | no | none |
| dm7 | Tm7 | b2 | yes | 1.11/1.03 | fail | fail | yes | toner scattering |
| DY1 | TY1 | A1 | no | 1.45/1.39 | pass | pass | no | none |
| DY2 | TY2 | A2 | no | 1.44/1.48 | pass | pass | no | none |
| DY3 | TY3 | A3 | no | 1.42/1.45 | pass | pass | no | none |
| DY4 | TY4 | A4 | no | 1.45/1.47 | pass | pass | no | none |
| DY5 | TY5 | A1 | no | 1.41/1.45 | pass | pass | no | none |
| DY6 | TY6 | A2 | no | 1.41/1.47 | pass | pass | no | none |
| dy7 | Ty7 | b3 | yes | 1.18/1.03 | fail | fail | yes | toner scattering |
| DC1 | TC1 | A1 | no | 1.44/1.48 | pass | pass | no | none |
| DC2 | TC2 | A2 | no | 1.43/1.50 | pass | pass | no | none |
| DC3 | TC3 | A3 | no | 1.51/1.53 | pass | pass | no | none |
| DC4 | TC4 | A4 | no | 1.43/1.45 | pass | pass | no | none |
| DC5 | TC5 | A1 | no | 1.44/1.45 | pass | pass | no | none |
| DC6 | TC6 | A2 | no | 1.46/1.50 | pass | pass | no | none |
| dc7 | Tc7 | b4 | yes | 1.22/1.02 | fail | fail | yes | toner scattering |
| DB1 | TB1 | A1 | no | 1.42/1.45 | pass | pass | no | none |
| DB2 | TB2 | A2 | no | 1.47/1.49 | pass | pass | no | none |
| DB3 | TB3 | A3 | no | 1.45/1.49 | pass | pass | no | none |
| DB4 | TB4 | A4 | no | 1.41/1.46 | pass | pass | no | none |
| DB5 | TB5 | A1 | no | 1.43/1.47 | pass | pass | no | none |
| DB6 | TB6 | A2 | no | 1.44/1.49 | pass | pass | no | none |
| db7 | Tb7 | b1 | yes | 1.21/1.03 | fail | fail | yes | toner scattering |

TABLE 15

| | First color | Second color | Third color | Fourth color | | Partial transfer | Adhesion to |
|---|---|---|---|---|---|---|---|
| | developer | developer | developer | developer | Back-transfer | defects | fixing belt |
| CC1 | DY1 | DM1 | DC1 | DB1 | no | no | no |
| CC2 | DY2 | DM2 | DC2 | DB2 | no | no | no |
| CC3 | DY3 | DM3 | DC3 | DB3 | no | no | no |
| CC4 | DY4 | DM4 | DC4 | DB4 | no | no | no |
| CC5 | DY5 | DM5 | DC5 | DB5 | no | no | no |
| CC6 | DY6 | DM6 | DC6 | DB6 | no | no | no |
| cc7 | dy7 | dm7 | dc7 | db7 | yes | yes | yes |

When images were produced using the developers, there was no horizontal line disruption, toner scattering, or partial transfer defects in characters, the solid black images were uniform, the resulting images were of extremely high quality and resolution and were reproduced at 16 lines/mm, and high density images having a density of 1.3 or more were obtained. No background fogging occurred in the non-image portions. Furthermore, when a long-term durability test was conducted with 10,000 sheets of A4 paper, there was little change in fluidity and image density, and the characteristics were stable. Uniformity was also good when an overall solid image was formed during developing, and no developing memory occurred. There were no streaks in the images in continuous use. Nor was there any toner-spent onto the carrier. There was little change in carrier resistance or decrease in charge amount, and no fogging occurred. There was almost no fluctuation in the charge amount, whether under high or low temperature and humidity. The partial transfer defects that occurred during transfer were at a level low enough to pose no practical problem, and transfer efficiency was about 95%. Also, toner filming on the photosensitive member and the transfer belt was low enough to pose no practical problem. The transfer belt could be adequately cleaned. Almost no toner disruption or toner scattering occurred during fixing. Further, no transfer defects occurred in full-color images consisting of three overlapping colors, and the paper did not adhere to the fixing belt during fixing.

However, with the developers dm7, dy7, dc7, and db7, skipped characters during transfer, partial transfer defects, and back-transfer were more or less at acceptable levels when the process speed was 100 mm/s and the photosensitive member gap was 70 mm, but when the process speed was raised to 125 mm/s, or when the photosensitive member gap was lowered to 60 mm, skipped characters during transfer, partial transfer defects, and back-transfer occurred at levels that were not practically acceptable. Fogging and filming of the photosensitive members also occurred more often.

Toner-spent on the carrier also occurred more frequently, there was considerable change in carrier resistance, the charge amount decreased, and fogging tended to increase. Also observed were an increase in fogging caused by a decrease in charge amount under high temperature and humidity, and a decrease in image density caused by an increase in charge amount under low temperature and humidity. The transfer efficiency dropped to about 60 to 70%. Fogging and filming of the transfer belt also occurred more often. There was thinness at the rear half when an overall solid image was formed during developing. Wax fused to the developing blade during continuous use, and streaks appeared in the images. The paper adhered to the transfer belt during the output of images consisting of three overlapping colors. Toner scattering occurred during fixing.

Next, an offset resistance test was conducted with a fixing apparatus featuring a belt not coated with oil, in which a solid image applied in an amount of at least 1.2 mg/cm² to an OHP sheet was produced at a process speed of 125 mm/s. No jamming of the OHP sheets occurred in the fixing nip. When an overall solid green image was formed on plain paper, no offset whatsoever occurred up to the 122,000^{th} sheet. No degradation of the belt surface was seen even though it was a silicone or fluorine-based fixing belt not coated with oil. Optical transmissivity and high-temperature offset resistance were evaluated. The transmissivity of light of 700 nm was measured with a U-3200 spectrophotometer (Hitachi) at a process speed of 125 mm/s and a fixing temperature of 180° C. Table 16 shows the results for fixability, offset resistance, and storage stability.

TABLE 16

| | OHP transmissivity | High-temp. offset | |
|---|---|---|---|
| | (%) | resistance temp. (° C.) | Storage stability test |
| TM1 | 88.8 | 210 | pass |
| TM2 | 89.7 | 200 | pass |
| TM3 | 91.2 | 210 | pass |
| TM4 | 92.5 | 200 | pass |
| TM5 | 93.2 | 210 | pass |
| TM6 | 91.8 | 210 | pass |
| tm7 | 88.9 | offset occurred over | fail |
| | | entire temp. range | |

OHP transmissivity was over 80%, and the offset resistance temperature range was from 40 to 60° C., meaning that good fixability was exhibited with a fixing roller not coated with oil. Almost no agglomeration was seen in a storage stability test for 5 hours at 60° C.

The toner tm7, on the other hand, caked in the storage stability test, and its offset resistance temperature range was narrow.

### INDUSTRIAL APPLICABILITY

The present invention involves the use of a two-component developer in which a toner, to which a specific wax is added and which contains specific additives, is combined with a carrier in which a fluorine-modified silicone resin containing an aminosilane coupling agent serves as a coating resin. This makes possible oil-less fixing, in which offset can be prevented while maintaining OHP transmissivity, even without the use of an oil. This also eliminates toner-spent on the carrier, and extends the service life of the developer.

1. A two-component developer comprising a carrier and a toner containing a binder resin, a colorant, a wax, and an additive,
wherein the carrier comprises a core material whose surface is coated with a resin composition containing an aminosilane coupling agent and a fluorine-modified silicone resin, and
the wax contained in the toner is at least one wax selected from the following A, B, C or D:
A) a synthetic wax with a DSC endothermic peak temperature of 80 to 120° C. and an acid value of 5 to 80 mgKOH/g, obtained by reacting at least a C₄ to C₃₀ long chain alkyl alcohol, an unsaturated polycarboxylic acid or anhydride thereof, and an unsaturated hydrocarbon wax;
B) an ester wax with a DSC endothermic peak temperature of 50 to 120° C., an iodine value of 25 or less, and a saponification value of 30 to 300;
C) at least one fatty acid amide wax selected from among C₁₆ to C₂₄ aliphatic amide waxes and alkylene bis fatty acid amides of saturated, monounsaturated, or diunsaturated fatty acids; and
D) at least one type of fatty acid ester wax selected from among hydroxystearic acid derivatives, glycerol fatty acid esters, glycol fatty acid esters, and sorbitan fatty acid esters.

2. The two-component developer according to claim 1, wherein the toner is produced by the external addition of at least an inorganic micropowder whose average particle size is from 6 to 120 nm in an amount of 1.0 to 5.5 parts by weight per 100 parts by weight of a toner matrix containing the synthetic wax of A above.

3. The two-component developer according to claim 2, wherein, in the molecular weight distribution of the synthetic wax by gel permeation chromatography (GPC), the weight average molecular weight is from 1000 to 6000, the Z average molecular weight is from 1500 to 9000, the ratio of weight average molecular weight to number average molecular weight (weight average molecular weight/number average molecular weight) is from 1.1 to 3.8, the ratio of the Z average molecular weight to the number average molecular weight (Z average molecular weight/number average molecular weight) is from 1.5 to 6.5, and there is at least one molecular weight maximum peak in the region from 1×10³ to 3×10⁴.

4. The two-component developer according to claim 1, wherein the toner is produced by the external addition of at least an inorganic micropowder whose average particle size is from 6 to 120 nm in an amount of 1.0 to 5.5 parts by weight per 100 parts by weight of a toner matrix containing the ester wax of B above.

5. The two-component developer according to claim 4, wherein, in the molecular weight distribution of the ester wax by gel permeation chromatography (GPC), the number average molecular weight is from 100 to 5000, the weight average molecular weight is from 200 to 10,000, the ratio of weight average molecular weight to number average molecular weight (weight average molecular weight/number average molecular weight) is from 1.01 to 8, the ratio of the Z average molecular weight to the number average molecular weight (Z average molecular weight/number average molecular weight) is from 1.02 to 10, there is at least one molecular weight maximum peak in the region from 5×10² to 1×10⁴, and the weight loss on heating at 220° C. is no more than 8 wt %.

6. The two-component developer according to claim 1, wherein the toner is produced by the external addition of at least an inorganic micropowder whose average particle size is from 6 to 120 nm in an amount of 1.0 to 5.5 parts by weight per 100 parts by weight of a toner matrix containing the fatty acid amide wax of C above.

7. The two-component developer according to claim 1, wherein the toner is produced by the external addition of at least an inorganic micropowder whose average particle size is from 6 to 120 nm in an amount of 1.0 to 5.5 parts by weight per 100 parts by weight of a toner matrix containing the fatty acid ester wax of D above.

8. The two-component developer according to claim 1, wherein the toner is produced by the external addition of:
an inorganic micropowder whose average particle size is from 6 to 20 nm and whose ignition loss is from 0.5 to 25 wt % in an amount of 0.5 to 2 parts by weight per 100 parts by weight of a toner matrix, and
an inorganic micropowder whose average particle size is from 30 to 120 nm and whose ignition loss is from 0.1 to 23 wt % in an amount of 0.5 to 3.5 parts by weight per 100 parts by weight of a toner matrix.

9. The two-component developer according to claim 1, wherein the toner is produced by the external addition of a negatively-chargeable inorganic micropowder whose average particle size is from 6 to 120 nm and whose ignition loss is from 0.5 to 25 wt % in an amount of 0.8 to 4 parts by weight per 100 parts by weight of a toner matrix,
and of a positively-chargeable inorganic micropowder whose average particle size is from 6 to 120 nm and whose ignition loss is from 0.5 to 25 wt % in an amount of 0.2 to 1.5 parts by weight per 100 parts by weight of a toner matrix.

10. The two-component developer according to claim 1, wherein the toner is produced by the external addition of:
a negatively-chargeable inorganic micropowder whose average particle size is from 6 to 20 nm and whose ignition loss is from 0.5 to 25 wt % in an amount of 0.6 to 2 parts by weight per 100 parts by weight of toner matrix particles,
a negatively-chargeable inorganic micropowder whose average particle size is from 30 to 120 nm and whose ignition loss is from 0.1 to 23 wt % in an amount of 0.2 to 2.0 parts by weight per 100 parts by weight of toner matrix particles, and
a positively-chargeable inorganic micropowder whose average particle size is from 6 to 20 nm and whose ignition loss is from 0.5 to 25 wt % in an amount of 0.2 to 1.5 parts by weight per 100 parts by weight of toner matrix particles.

11. The two-component developer according to claim 1, wherein the resin coating the carrier contains 5 to 40 parts by weight of an aminosilane coupling agent per 100 parts by weight coating resin.

12. The two-component developer according to claim 1, wherein the blend proportion of the toner and carrier is such that the toner accounts for at least 2 wt % and no more than 10 wt %, and the carrier for at least 90 wt % and no more than 98 wt %.

13. The two-component developer according to claim 1, wherein the additive is added in a proportion of at least 1.5 wt % and no more than 6 wt % per 100 parts by weight of toner.

14. The two-component developer according to claim 1, wherein the fluorine-modified silicone resin is a crosslinkable fluorine-modified silicone resin obtained by reacting a perfluoroalkyl group-containing organosilicon compound with a polyorganosiloxane.

15. The two-component developer according to claim 14, wherein the perfluoroalkyl group-containing organosilicon compound is at least one compound selected from among CF₃CH₂CH₂Si(OCH₃)₃, C₄F₉CH₂CH₂Si(CH₃)(OCH₃)₂, C₈F₁₇CH₂CH₂Si(OCH₃)₃, C₈F₁₇CH₂CH₂Si(OC₂H₅)₃, and (CH₃)₂CF(CF₂)₈CH₂CH₂Si(OCH₃)₃.

16. The two-component developer according to claim 14, wherein the polyorganosiloxane is at least one type selected from among Chemical Formulas 1 and 2 below: 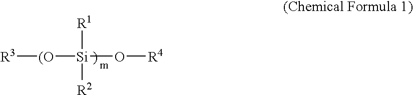
(where R¹ and R² are each a hydrogen atom, halogen atom, hydroxy group, methoxy group, or C₁ to C₄ alkyl group or phenyl group, R³ and R⁴ are each a C₁ to C₄ alkyl group or phenyl group, and m is a positive integer indicating the average degree of polymerization) 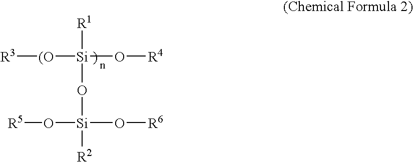
(where R¹ and R² are each a hydrogen atom, halogen atom, hydroxy group, methoxy group, or C₁ to C₄ alkyl group or phenyl group, R³, R⁴, R⁵, and R⁶ are each a C₁ to C₄ alkyl group or phenyl group, and n is a positive integer indicating the average degree of polymerization).

17. The two-component developer according to claim 14, wherein the fluorine-modified silicone resin is a crosslinkable fluorine-modified silicone resin obtained by reacting a perfluoroalkyl group-containing organosilicon compound in an amount of at least 3 parts by weight and no more than 20 parts by weight with 100 parts by weight of a polyorganosiloxane.

18. The two-component developer according to claim 1, wherein the aminosilane coupling agent is at least one type selected from among γ-(2-aminoethyl)aminopropyltrimethoxysilane, γ-(2-aminoethyl)aminopropylmethyldimethoxysilane, and octadecylmethyl[3-(trimethoxysilyl)propyl] ammonium chloride.

19. An image formation method, comprising a developing apparatus in which an AC bias with a frequency of 1 to 10 kHz and a bias of 1.0 to 2.5 kV (p-p) is applied along with a DC bias between a photosensitive member and a developing roller, and the peripheral speed ratio between the photosensitive member and the developing roller is from 1:1.2 to 1:2,
said method involving the use of a two-component developer comprising a carrier and a toner containing a binder resin, a colorant, a wax, and an additive, the carrier comprising a core material whose surface is coated with a resin composition containing an aminosilane coupling agent and a fluorine-modified silicone resin, and the wax contained in the toner being at least one wax selected from the following A, B, C or D:
A) a synthetic wax with a DSC endothermic peak temperature of 80 to 120° C. and an acid value of 5 to 80 mgKOH/g, obtained by reacting at least a C₄ to C₃₀ long chain alkyl alcohol, an unsaturated polycarboxylic acid or anhydride thereof, and an unsaturated hydrocarbon wax;
B) an ester wax with a DSC endothermic peak temperature of 50 to 120° C., an iodine value of 25 or less, and a saponification value of 30 to 300;
C) at least one fatty acid amide wax selected from among C₁₆ to C₂₄ aliphatic amide waxes and alkylene bis fatty acid amides of saturated, monounsaturated, or diunsaturated fatty acids; and
D) at least one type of fatty acid ester wax selected from among hydroxystearic acid derivatives, glycerol fatty acid esters, glycol fatty acid esters, and sorbitan fatty acid esters.

20. An image formation method, comprising a transfer system in which there are a plurality of toner image forming stations including at least an image support, charging means for forming an electrostatic latent image on the image support, and a toner support, the electrostatic latent image formed on the image support is visualized using a two-component developer comprising a carrier and a toner containing a binder resin, a colorant, a wax, and an additive,
the carrier comprising a core material whose surface is coated with a resin composition containing an aminosilane coupling agent and a fluorine-modified silicone resin, and
the wax contained in the toner being at least one wax selected from the following A, B, C or D:
A) a synthetic wax with a DSC endothermic peak temperature of 80 to 120° C. and an acid value of 5 to 80 mgKOH/g, obtained by reacting at least a C₄ to C₃₀ long chain alkyl alcohol, an unsaturated polycarboxylic acid or anhydride thereof, and an unsaturated hydrocarbon wax;
B) an ester wax with a DSC endothermic peak temperature of 50 to 120° C., an iodine value of 25 or less, and a saponification value of 30 to 300;
C) at least one fatty acid amide wax selected from among C₁₆ to C₂₄ aliphatic amide waxes and alkylene bis fatty acid amides of saturated, monounsaturated, or diunsaturated fatty acids; and
D) at least one type of fatty acid ester wax selected from among hydroxystearic acid derivatives, glycerol fatty acid esters, glycol fatty acid esters, and sorbitan fatty acid esters,
a primary transfer process, in which the toner image produced by the visualization of the electrostatic latent image is transferred to an endless transfer member by bringing the transfer member into contact with the image support, is sequentially and continuously executed to form a multilayer transferred toner image on the transfer member, and then a secondary transfer process, in which the multilayer toner image formed on the transfer member is transferred all at once to a transfer medium, is executed, and the transfer processes form an image under a condition of d1/v≦0.65 (sec), when d1 (mm) is a distance from a first primary transfer position to a second primary transfer position, or a distance from the second primary transfer position to a third primary transfer position, or a distance from the third primary transfer position to a fourth primary transfer position, and v (mm/s) is the peripheral speed of the photosensitive member.

21. An image formation method, comprising a transfer system in which there are a plurality of toner image forming stations consisting of at least an image support, charging means for forming an electrostatic latent image on the image support, and a toner support, the electrostatic latent image formed on the image support is visualized using a two-component developer comprising a carrier and a toner containing a binder resin, a colorant, a wax, and an additive,
the carrier comprising a core material whose surface is coated with a resin composition containing an aminosilane coupling agent and a fluorine-modified silicone resin, and
the wax contained in the toner being at least one wax selected from the following A, B, C or D:
A) a synthetic wax with a DSC endothermic peak temperature of 80 to 120° C. and an acid value of 5 to 80 mgKOH/g, obtained by reacting at least a C₄ to C₃₀ long chain alkyl alcohol, an unsaturated polycarboxylic acid or anhydride thereof, and an unsaturated hydrocarbon wax;
B) an ester wax with a DSC endothermic peak temperature of 50 to 120° C., an iodine value of 25 or less, and a saponification value of 30 to 300;
C) at least one fatty acid amide wax selected from among C₁₆ to C₂₄ aliphatic amide waxes and alkylene bis fatty acid amides of saturated, monounsaturated, or diunsaturated fatty acids; and
D) at least one type of fatty acid ester wax selected from among hydroxystearic acid derivatives, glycerol fatty acid esters, glycol fatty acid esters, and sorbitan fatty acid esters,
a transfer process is executed in which the toner image produced by the visualization of the electrostatic latent image is transferred sequentially and continuously to a transfer medium, and the transfer process forms an image under a condition of d1/v≦0.65 (sec), when d1 (mm) is a distance from a first primary transfer position to a second primary transfer position, or a distance from the second primary transfer position to a third primary transfer position, or a distance from the third primary transfer position to a fourth primary transfer position, and v (mm/s) is the peripheral speed of the photosensitive member.
